(19) United States
(12) Patent Application Publication
(10) Pub. No.: US 2023/0113397 A1
(43) Pub. Date: Apr. 13, 2023

(54) ANTENNA DEVICE

(71) Applicant: SONY SEMICONDUCTOR SOLUTIONS CORPORATION, KANAGAWA (JP)

(72) Inventors: TAKAYUKI HIRABAYASHI, TOKYO (JP); OSAMU KOZAKAI, KANAGAWA (JP)

(21) Appl. No.: 17/904,500

(22) PCT Filed: Feb. 9, 2021
(86) PCT No.: PCT/JP2021/004707

§ 371 Date: Aug. 18, 2022

(30) Foreign Application Priority Data
Feb. 27, 2020 (JP) 2020-031935
Jun. 30, 2020 (JP) 2020-113606

(51) Int. Cl. H01Q 21/24; H01Q 1/50; H01Q 13/10; H01Q 9/30; H01Q 25/04

(52) U.S. Cl. CPC H01Q 21/24; H01Q 1/50; H01Q 13/106; H01Q 9/30; H01Q 25/04

(57) ABSTRACT

An antenna device includes a first antenna (10) that radiates a first polarized wave; a second antenna (20) that radiates a second polarized wave; parasitic elements (11, 12, 21, 22); a base plate (30), and a switch group, the switch group including switches (111, 121, 211, 212, 221, 222) connected to the parasitic elements and switches (301 to 308) connected to the base plate.

### FIELD

The present disclosure relates to an antenna device.

### BACKGROUND

Various methods for switching the antenna directivity and polarization (radiation pattern) have been proposed (refer to Patent Literatures 1 to 3, for example).

### CITATION LIST

### Patent Literature

Patent Literature 1: WO 2011/080903 A

Patent Literature 2: JP 2012-120150 A

Patent Literature 3: JP 2010-199859 A

### SUMMARY

### Technical Problem

There is still room for improvement in terms of increasing the degree of freedom in controlling antenna radiation patterns.

An object of the present disclosure is to provide an antenna device capable of controlling radiation patterns with a high degree of freedom, an electronic device, and an antenna device control method.

### Solution to Problem

An antenna device according to one aspect of the present disclosure includes a first antenna that radiates a first polarized wave, a second antenna that radiates a second polarized wave, a parasitic element, a base plate, and a switch group including a switch connected to the parasitic element and a switch connected to the base plate.

### BRIEF DESCRIPTION OF DRAWINGS

FIG. 1 is a perspective view illustrating an example of a schematic configuration of an antenna device according to a first embodiment.

FIG. 2 is a plan view illustrating an example of a schematic configuration of an antenna device.

FIG. 3 is a diagram illustrating an example of a schematic configuration of SPST.

FIG. 4A is a diagram illustrating an example of a power feeding scheme.

FIG. 4B is a diagram illustrating an example of a power feeding scheme.

FIG. 4C is a diagram illustrating an example of a power feeding scheme.

FIG. 5 is a diagram illustrating an example of a schematic configuration of SPDT.

FIG. 6 is a diagram illustrating an example of a schematic configuration of an antenna device and an electronic device on which the antenna device is mounted.

FIG. 7 is a diagram illustrating an example of a State.

FIG. 8A is a diagram illustrating a simulation result.

FIG. 8B is a diagram illustrating a simulation result.

FIG. 8C is a diagram illustrating a simulation result.

FIG. 9A is a diagram illustrating a simulation result.

FIG. 9B is a diagram illustrating a simulation result.

FIG. 9C is a diagram illustrating a simulation result.

FIG. 10 is a diagram illustrating a simulation result.

FIG. 11 is a flowchart illustrating an example of switching control processing.

FIG. 12 is a plan view illustrating an example of a schematic configuration of an antenna device according to a modification.

FIG. 13 is a plan view illustrating an example of a schematic configuration of an antenna device according to a modification.

FIG. 14 is a plan view illustrating an example of a schematic configuration of an antenna device according to a modification.

FIG. 15 is a plan view illustrating an example of a schematic configuration of an antenna device according to a modification.

FIG. 16 is a plan view illustrating an example of a schematic configuration of an antenna device according to a modification.

FIG. 17 is a plan view illustrating an example of a schematic configuration of an antenna device according to a modification.

FIG. 18 is a plan view illustrating an example of a schematic configuration of an antenna device according to a second embodiment.

FIG. 19 is a diagram illustrating an example of a State.

FIG. 20A is a diagram illustrating a simulation result.

FIG. 20B is a diagram illustrating a simulation result.

FIG. 20C is a diagram illustrating a simulation result.

FIG. 20D is a diagram illustrating a simulation result.

FIG. 20E is a diagram illustrating simulation results.

FIG. 21A is a diagram illustrating a simulation result.

FIG. 21B is a diagram illustrating a simulation result.

FIG. 21C is a diagram illustrating a simulation result.

FIG. 21D is a diagram illustrating a simulation result.

FIG. 21E is a diagram illustrating simulation results.

FIG. 22A is a diagram illustrating a simulation result.

FIG. 22B is a diagram illustrating a simulation result.

FIG. 22C is a diagram illustrating a simulation result.

FIG. 22D is a diagram illustrating a simulation result.

FIG. 22E is a diagram illustrating simulation results.

FIG. 23A is a diagram illustrating a simulation result.

FIG. 23B is a diagram illustrating a simulation result.

FIG. 23C is a diagram illustrating a simulation result.

FIG. 23D is a diagram illustrating a simulation result.

FIG. 23E is a diagram illustrating simulation results.

FIG. 24A is a diagram illustrating a simulation result.

FIG. 24B is a diagram illustrating a simulation result.

FIG. 24C is a diagram illustrating a simulation result.

FIG. 24D is a diagram illustrating a simulation result.

FIG. 24E is a diagram illustrating simulation results.

FIG. 25A is a diagram illustrating a simulation result.

FIG. 25B is a diagram illustrating a simulation result.

FIG. 25C is a diagram illustrating a simulation result.

FIG. 25D is a diagram illustrating a simulation result.

FIG. 25E is a diagram illustrating simulation results.

FIG. 26A is a diagram illustrating a simulation result.

FIG. 26B is a diagram illustrating a simulation result.

FIG. 26C is a diagram illustrating a simulation result.

FIG. 26D is a diagram illustrating a simulation result.

FIG. 26E is a diagram illustrating simulation results.

FIG. 27A is a diagram illustrating a simulation result.

FIG. 27B is a diagram illustrating a simulation result.

FIG. 27C is a diagram illustrating a simulation result.

FIG. 27D is a diagram illustrating a simulation result.

FIG. 27E is a diagram illustrating simulation results.

FIG. 28 is a diagram illustrating a simulation result.

FIG. 29 is a diagram illustrating a prototype.

FIG. 30A is a diagram illustrating experimental results.

FIG. 30B is a diagram illustrating experimental results.

FIG. 30C is a diagram illustrating experimental results.

FIG. 31 is a diagram illustrating experimental results.

FIG. 32 is a plan view illustrating an example of a schematic configuration of an antenna device according to a modification.

FIG. 33 is a plan view illustrating an example of a schematic configuration of an antenna device according to a modification.

FIG. 34 is a plan view illustrating an example of a schematic configuration of an antenna device according to a modification.

FIG. 35 is a diagram illustrating an example of a State.

FIG. 36A is a diagram schematically illustrating an example of information regarding frequency characteristics.

FIG. 36B is a diagram schematically illustrating an example of information regarding frequency characteristics.

FIG. 36C is a diagram schematically illustrating an example of information regarding frequency characteristics.

FIG. 37 is a diagram schematically illustrating an example of information regarding a time-axis waveform.

FIG. 38 is a diagram illustrating an example of a schematic configuration of an antenna device and an electronic device on which the antenna device is mounted.

FIG. 39 is a flowchart illustrating an example of switching control processing.

FIG. 40 is a flowchart illustrating an example of switching control processing.

### DESCRIPTION OF EMBODIMENTS

Embodiments of the present disclosure will be described below in detail with reference to the drawings. In each of the following embodiments, the same parts are denoted by the same reference numerals, and a repetitive description thereof will be omitted.

The present disclosure will be described in the following order.
1. First embodiment
1.1 Example of schematic configuration of antenna device
1.2 Example of power feeding scheme
1.3 Example of schematic configuration of control system
1.4 Example of States

11.5 Simulation result
1.6 Modification
2. Second embodiment
2.1 Example of schematic configuration of antenna device
2.2 Example of States
2.3 Simulation result
2.4 Experimental results
2.5 Modification
3. Further examples of control system
4. Effects

### 1. First Embodiment

### 1.1 Example of Schematic Configuration of Antenna Device

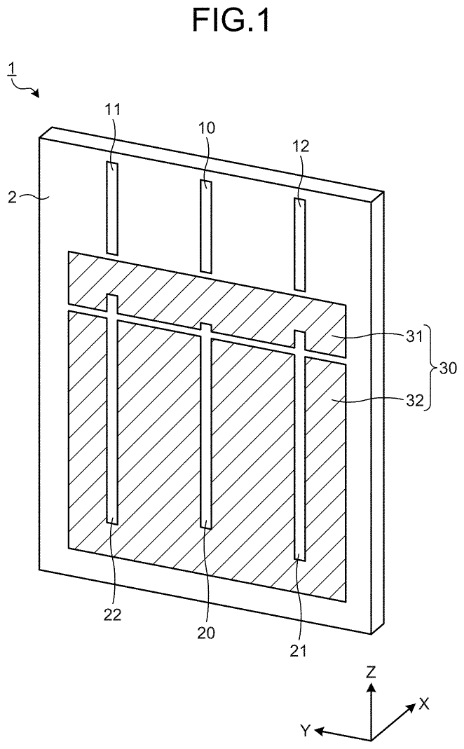

FIG. 1 is a perspective view illustrating an example of a schematic configuration of an antenna device according to an embodiment. An antenna device 1 illustrated in FIG. 1 includes a substrate 2, an antenna 10, a parasitic element 11, a parasitic element 12, an antenna 20, a parasitic element 21, a parasitic element 22, and a base plate 30. In the drawing, the base plate 30 is indicated by hatch patterns. In the figure, XYZ coordinates are illustrated. The Z-axis direction corresponds to the vertical direction, and the X-axis direction and the Y-axis direction correspond to the horizontal directions.

The substrate 2 is a planar substrate. Being formed to have thickness in the X-axis direction, the substrate 2 has a front surface (surface on the X-axis negative direction side) and a back surface (surface on the X-axis positive direction side) extending in the Y-axis direction and the Z direction. Hereinafter, unless otherwise specified, the term “on the substrate 2” means on the front surface of the substrate 2. The substrate 2 is, for example, a dielectric substrate having insulating properties.

The antenna 10 is a first antenna provided on the substrate 2 so as to radiate a first polarized wave. The first polarized wave is either a vertically polarized wave or a horizontally polarized wave. The vertically polarized wave is an electromagnetic wave in which an electric field component in a vertical direction is dominant. The horizontally polarized wave is an electromagnetic wave in which an electric field component in a horizontal direction is dominant. The antenna 10 illustrated in FIG. 1 is a linear rectangular (rod-shaped) conductive member (for example, a metal pattern) provided on the substrate 2 so as to extend in the Z-axis positive direction from a base end (portion on the divided base plate 31 side) toward the tip end. The antenna 10 may be a rod-shaped monopole antenna that radiates a vertically polarized wave. When a wavelength of a specific frequency (for example, a center frequency) in the transmission/reception band of the antenna 10 is a wavelength λ₁, the length (length in the Z-axis direction) of the antenna 10 is set to 0.25λ₁, for example.

The parasitic element 11 and the parasitic element 12 are a pair of parasitic elements provided to have an effect on the directivity of antenna 10. In this example, the parasitic element 11 and the parasitic element 12 are rod-shaped conductive members provided on the substrate 2 so as to extend in the Z-axis positive direction from the base end (portion on the divided base plate 31 side) toward the tip end. The parasitic element 11 and the parasitic element 12 are provided on either side of the antenna 10 so as to each face the antenna 10 in the Y-axis direction. The parasitic element 11 and the parasitic element 12 are disposed at an interval of 0.25λ₁ from the antenna 10, for example.

The antenna 20 is a second antenna provided on the substrate 2 so as to radiate the second polarized wave. The second polarized wave may be a polarized wave in the same direction as the first polarized wave radiated by the antenna 10, or may be a polarization in a direction different from the first polarized wave. The antenna 20 exemplified in FIG. 1 is a rod-shaped slot line provided on the substrate 2 so as to extend in the Z-axis negative direction from the base end (the portion near the boundary between the divided base plate 31 side and a divided base plate 32) toward the tip end. The antenna 20 is a slot antenna that radiates a horizontally polarized wave. The antenna 20 is provided so as to be located on the opposite side of the antenna 10 across the divided base plate 31 in the Z-axis direction. When a wavelength of a specific frequency (for example, a center frequency) in the transmission/reception band of the antenna 20 is a wavelength λ₂, the length (length in the Z-axis direction) of the antenna 20 is set to 0.5λ₂, for example.

The parasitic element 21 and the parasitic element 22 are a pair of parasitic elements provided to have an effect on the directivity of antenna 20. In this example, the parasitic element 11 and the parasitic element 22 are rod-shaped slot line provided on the substrate 2 so as to extend in the Z-axis negative direction from the base end (portion on the divided base plate 31 side) toward the tip end. The parasitic element 21 and the parasitic element 22 are provided on either side of the antenna 20 so as to each face the antenna 20 in the Y-axis direction. The parasitic element 21 and the parasitic element 22 are disposed at an interval of 0.25λ₂ from the antenna 20, for example.

The base plate 30 is a base plate that has an effect on the directivity of the antenna 10 and the antenna 20. In this example, the base plate 30 includes the divided base plate 31 and the divided base plate 32.

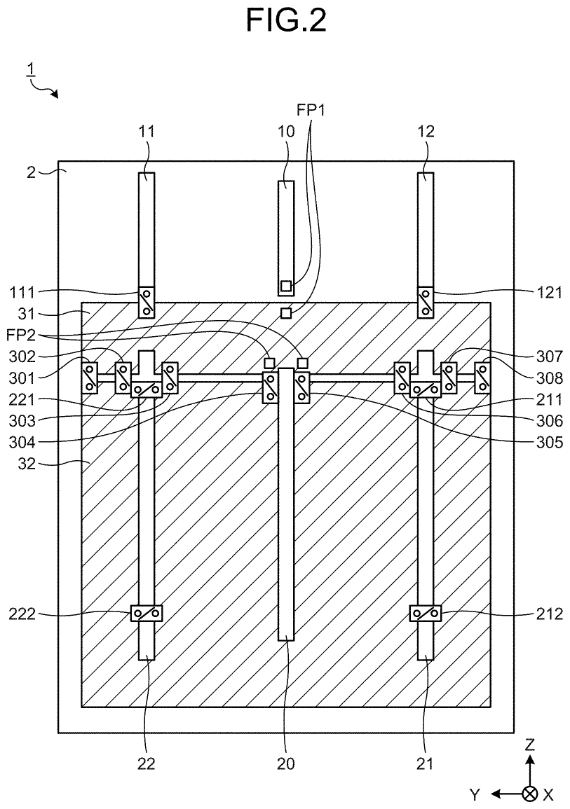

The divided base plate 31 is a conductive member provided on the substrate 2 so as to have an effect on the directivity of the antenna 10 and/or the antenna 20. In this example, the divided base plate 31 has a substantially rectangular shape except for a portion where the antenna 20, the parasitic element 21, and the parasitic element 22 are provided. The divided base plate 31 is provided so as to face the antenna 10, the parasitic element 11, and the parasitic element 12 in the Z-axis direction. In the example illustrated in FIG. 2, the divided base plate 31 has a length (a length in the Z-axis direction) capable of forming the antenna 20 and a part of the parasitic elements 21 and 22 (a portion other than a portion formed by the divided base plate 32 described below).

The divided base plate 32 is a conductive member provided on the substrate 2 so as to have an effect on the directivity of the antenna 10 and/or the antenna 20. In this example, the divided base plate 32 has a substantially rectangular shape except for a portion where the antenna 20, the parasitic element 21, and the parasitic element 22 are provided. The divided base plate 32 is provided to face the divided base plate 31 so as to be located on the opposite side to the antenna 10, the parasitic element 11, and the parasitic element 12 across the divided base plate 31 in the Z-axis direction. The divided base plate 32 may have the same width (length in the Y-axis direction) as the divided base plate 31. The divided base plate 32 has a length (a length in the Z-axis direction) capable of forming the antenna 20, the parasitic element 21, and the parasitic element 22.

Furthermore, the antenna device 1 is equipped with a switch group including a plurality of switches. This will be described next with reference to FIG. 2.

FIG. 2 is a plan view illustrating a schematic configuration of the antenna device 1. FIG. 2 illustrates a feeding point FP1, a feeding point FP2, and a switch group in addition to the components of antenna device 1 described above with reference to FIG. 1. In this example, the switch group includes a switch 111, a switch 121, a switch 211, a switch 212, a switch 221, a switch 222, and switches 301 to 308.

The feeding point FP1 is provided on a substrate portion of the antenna 10 and on the divided base plate 31. The feeding point FP2 is provided at the base end of the antenna 20. Alternatively, this is provided on a certain position of the antenna 20 along the Z axis.

The switch 111 is connected to the parasitic element 11. In this example, the switch 111 is connected between the base end of the parasitic element 11 and the divided base plate 31. When the switch 111 is set to SHORT (ON: short circuit), the parasitic element 11 is connected to the divided base plate 31. When the switch 111 is set to OPEN (OFF: open), the parasitic element 11 is separated from the divided base plate 31.

The switch 121 is connected to the parasitic element 12. In this example, the switch 121 is connected between the base end of the parasitic element 12 and the divided base plate 31. When the switch 121 is set to SHORT, the parasitic element 12 is connected to the divided base plate 31. When the switch 121 is set to OPEN, the parasitic element 12 is separated from the divided base plate 31.

The switch 211 and the switch 212 are connected to the parasitic element 21. In this example, the switch 211 is connected between the divided base plates 32 on both sides at the base end of the parasitic element 21. When the switch 211 is set to SHORT, the parasitic element 21 becomes a slot line having a length ranging from the base end to the switch 211. The switch 212 is connected between the divided base plates 32 on both sides in a portion between the base end and the tip end of the parasitic element 21. When the switch 211 is set to OPEN and the switch 212 is set to SHORT, the parasitic element 21 becomes a slot line having a length ranging from the base end to the switch 212. In other words, the slot line from the switch 212 to the tip end is invalidated.

The switch 221 and the switch 222 are connected to the parasitic element 22. In this example, the switch 221 is connected between the divided base plates 32 on both sides at the base end of the parasitic element 22. When the switch 221 is set to SHORT, the parasitic element 21 becomes a slot line having a length ranging from the base end to the switch 221. The switch 222 is connected between the divided base plates 32 on both sides in a portion between the base end and the tip end of the parasitic element 22. When the switch 221 is set to OPEN and the switch 222 is set to SHORT, the parasitic element 22 becomes a slot line having a length ranging from the base end to the switch 222. In other words, the slot line from the switch 222 to the tip end is invalidated.

The switches 301 to 308 are connected to the base plate 30. In this example, the switches 301 to 308 are connected between the divided base plate 31 and the divided base plate 32 sequentially in the Y-axis direction.

The switch 301 is connected between the divided base plate 31 and the divided base plate 32 at the ends on the Y-axis positive direction side of the divided base plate 31 and the divided base plate 32. The switch 302 is connected between the divided base plate 31 and the divided base plate 32 at a portion on the Y-axis positive direction side in the base end of the parasitic element 22. The switch 303 is connected between the divided base plate 31 and the divided base plate 32 at a portion on the Y-axis negative direction side in the base end of the parasitic element 22. The switch 304 is connected between the divided base plate 31 and the divided base plate 32 at a portion on the Y-axis positive direction side in the base end of the antenna 20. The switch 305 is connected between the divided base plate 31 and the divided base plate 32 at a portion on the Y-axis negative direction side in the base end of the antenna 20. The switch 306 is connected between the divided base plate 31 and the divided base plate 32 at a portion on the Y-axis positive direction side in the base end of the parasitic element 21. The switch 307 is connected between the divided base plate 31 and the divided base plate 32 at a portion on the Y-axis negative direction side in the base end of the parasitic element 21. The switch 308 is connected between the divided base plate 31 and the divided base plate 32 at ends on the Y-axis negative direction side of the divided base plate 31 and the divided base plate 32.

As described above, a part of the antenna 20 may be formed of the divided base plate 31, and in this case, the switch 304 and the switch 305 connect different portions of the antenna 20, namely, the portion formed of the divided base plate 31 and the portion formed of the divided base plate 32. A part of the parasitic element 21 may be formed of the divided base plate 31, and in this case, the switch 306 and the switch 307 connect different portions of the parasitic element 21, namely, the portion formed of the divided base plate 31 and the portion formed of the divided base plate 32. A part of the parasitic element 22 may be formed of the divided base plate 31, and in this case, the switch 302 and the switch 303 connect in different portions of the parasitic element 22, namely, the portion formed of the divided base plate 31 and the portion formed of the divided base plate 32.

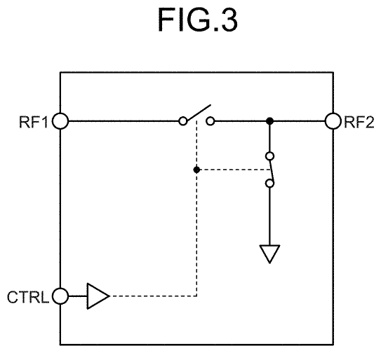

The switch 111, the switch 121, the switch 211, the switch 212, the switch 221, the switch 222, and the switches 301 to 308 are, for example, Single Pole Single Through (SPST) switches. FIG. 3 is a diagram illustrating an example of a schematic configuration of SPST. In the SPST illustrated in FIG. 3, the OPEN/SHORT between a terminal RF1 and a terminal RF2 is switched. The switching is controlled by a control signal CTRL. Note that switching can be performed so as to connect the terminal RF2 to the ground.

### 1.2 Example of Power Feeding Scheme

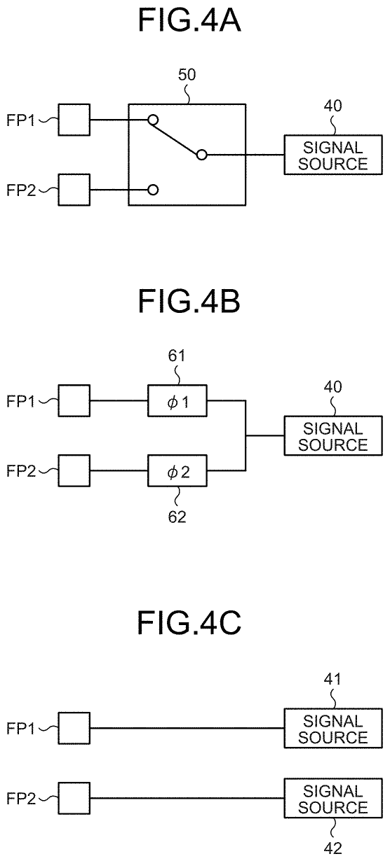

An example of a power feeding scheme using the feeding point FP1 and the feeding point FP2 will be described with reference to FIGS. 4A to 4C.

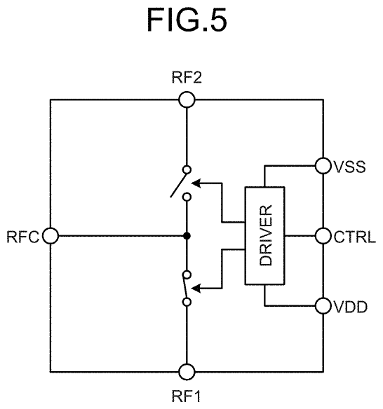

The power feeding scheme illustrated in FIG. 4A is an example of switching diversity. A signal source 40 generates a transmission RF signal. The transmission RF signal generated by the signal source 40 is selectively supplied to either the feeding point FP1 or the feeding point FP2 via a switch 50. This can switch between the radiation by the antenna 10 and the radiation by the antenna 20. Here, for example, Single Pole Double Through (SPDT) may be used as the switch 50. FIG. 5 is a diagram illustrating an example of a schematic configuration of SPDT. In the SPDT illustrated in FIG. 5, a DRIVER switches OPEN/SHORT between a terminal RFC and the terminal RF1 and OPEN/SHORT between the terminal RFC and the terminal RF2 according to the control signal CTRL. The DRIVER operates on a power supply voltage VSS and a power supply voltage VDD. Similarly, switching diversity may be used in reception.

The power feeding scheme illustrated in FIG. 4B is an example of combined diversity. The transmission RF signal generated by the signal source 40 is shifted in phase by a phase shifter 61 by a phase ϕ1 and then supplied to the feeding point FP1, while being shifted in phase by a phase shifter 62 by a phase ϕ2 and then supplied to the feeding point FP2. For example, in a case where the antenna 10 and the antenna 20 radiate polarized waves mutually traveling straight to each other, it is possible to form a radiation pattern by combining polarized waves and directivity. Similarly, it may be combined diversity in reception.

The power feeding scheme illustrated in FIG. 4C is an example of Multiple Input Multiple Output (MIMO). A signal source 41 and a signal source 42 generate mutually different transmission RF signals. The transmission RF signal generated by the signal source 41 is supplied to the feeding point FP1. The transmission RF signal generated by the signal source 42 is supplied to the feeding point FP2. In a case where the antenna 10 and the antenna 20 radiate polarized waves mutually traveling straight to each other, it is possible to implement MIMO with low correlation and high S/N. Similarly, MIMO can be implemented in reception.

### 1.3 Example of Schematic Configuration of Control System

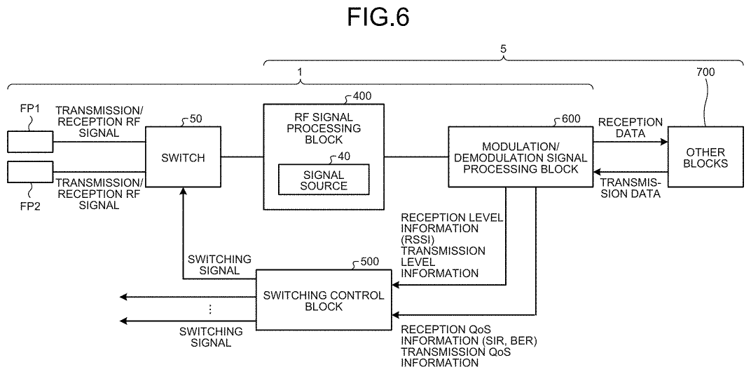

The antenna device 1 can include a control system that performs switching and the like of the switch 111 and the like described above. FIG. 6 is a diagram illustrating an example of a schematic configuration of an antenna device and an electronic device constituting such a control system.

In addition to the configuration described above, the antenna device 1 includes an RF signal processing block 400, a switching control block 500, and a modulation/demodulation signal processing block 600. The antenna device 1 is mounted on an electronic device 5, and a portion other than the antenna device 1 in the electronic device 5 is illustrated as other blocks 700. In this example, the power feeding scheme is switching diversity (FIG. 4A). The other blocks 700 are configured to supply transmission data to the modulation/demodulation signal processing block 600 of the antenna device 1 and receive reception data from the modulation/demodulation signal processing block 600.

An outline of a basic operation of transmission will be described. The modulation/demodulation signal processing block 600 generates a modulated signal based on the transmission data. The RF signal processing block 400 generates a transmission RF signal based on the modulated signal. The generated transmission RF signal is supplied to either the feeding point FP1 or the feeding point FP2 (FIG. 2) of the antenna device 1 via the switch 50.

An outline of a basic operation of reception will be described. The reception RF signal is supplied from the antenna device 1 to the RF signal processing block 400 via the switch 50. The RF signal processing block 400 performs processing (amplification, filtering, frequency conversion, and the like) on the reception RF signal. The modulation/demodulation signal processing block 600 demodulates the processed reception RF signal to obtain reception data.

Here, an index related to transmission and reception is transmitted to the switching control block 500. Examples of the index include, but are not limited to, reception level information (also referred to as a Received Signal Strength Indicator (RSSI)), transmission level information, reception Quality of Service (QoS) information (represented by signal-to-interference ratio (SIR) or Bit Error Rate (BER)), and transmission QoS information.

The switching control block 500 generates a switching signal for controlling each of the switch 50, the switch 111, the switch 121, the switch 211, the switch 212, the switch 221, the switch 222, the switches 301 to 308 (FIG. 2), and the switch 50. The switching signal is generated based on the above-described index transmitted from the modulation/demodulation signal processing block 600. For example, the switching control block 500 generates the switching signal so as to maximize at least one index of each index described above.

By the switching control by the switching control block 500, the antenna device 1 has various States as described below.

### 1.4 Example of States

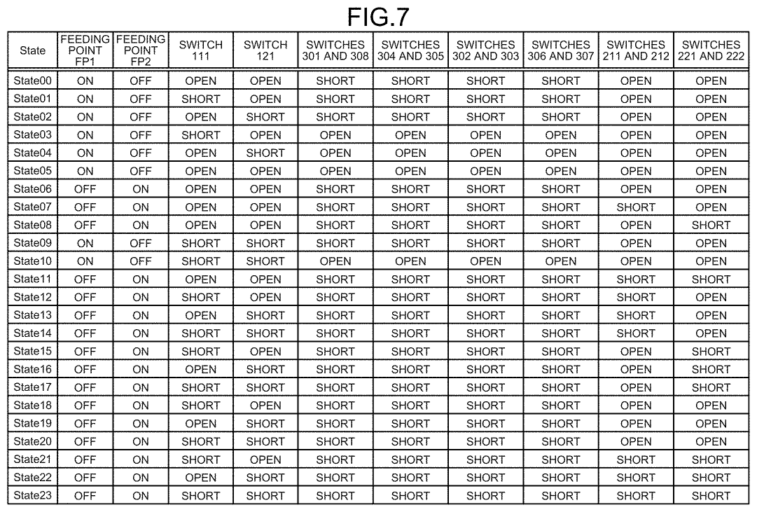

FIG. 7 is a diagram illustrating an example of States. FIG. 7 illustrates 24 State patterns of State 00 to State 23. “ON” indicates that power is supplied to the antenna by the corresponding feeding point, while “OFF” indicates that power is not supplied. “OPEN” indicates that the corresponding switch is in a non-conducting state (open), and “SHORT” indicates that the switch is in a conducting state (short circuit).

State 00 to State 05 are examples in which power is supplied only to the antenna 10 (excited) and switching is performed on the switches connected to the parasitic element 11, the parasitic element 12, the divided base plate 31, and the divided base plate 32. State 06 to State 08 are examples in which power is supplied only to the antenna 20, and switching is performed on the switches connected to the parasitic element 21 and the parasitic element 22. States 09 and 10 are examples in which power is supplied only to the antenna 10, and switching is performed on the switches connected to the parasitic element 21, the parasitic element 22, the divided base plate 31, and the divided base plate 32. State 11 to State 23 are examples in which power is supplied only to the antenna 20, and switching is performed on the switches connected to the parasitic element 11, the parasitic element 12, the parasitic element 21, and the parasitic element 22.

Note that it is also possible to obtain various States other than State 00 to State 23 described above. Example of other States include: a State in which power is supplied only to the antenna 10 and switching is performed on the switches connected to the parasitic element 11, the parasitic element 12, the parasitic element 21, and the parasitic element 22; and a State in which switching is independently performed on each switch connected between the divided base plate 31 and the divided base plate 32.

### 1.5 Simulation Result

Directivity simulation has been performed on the antenna device 1 (FIGS. 1 and 2, etc.) described above. Main simulation conditions are as follows.

Frequency: 815 MHz to 890 MHz

Lengths of the substrate 2 in the X, Y, and Z axis directions: 0.1 mm, 250 mm, and 330 mm, respectively.

Relative permittivity of substrate 2: 1.0.

Thickness and conductivity of a conductive member (metal pattern) provided on the substrate 2: 0.1 mm and 5.8×10⁷S/m.

Lengths of the antenna 10 in the Y and Z axis directions: 10 mm and 75 mm, respectively.

The lengths of the parasitic element 11 in the Y and Z axis directions: 10 mm and 80 mm, respectively.

The lengths of the parasitic element 12 in the Y and Z axis directions: 10 mm and 80 mm, respectively.

Distance between the antenna 10 and the parasitic element 11 in Y-axis direction: 75 mm.

Distance between the antenna 10 and the parasitic element 12 in Y-axis direction: 75 mm.

Lengths of antenna 20 in Y and Z axis directions (of slot): 10 mm and 170 m, respectively.

Lengths of the parasitic element 21 in the Y and Z axis directions: 10 mm and 190 m, respectively.

Distance between the switch 211 and the switch 212 in Z-axis direction: 5 mm.

The lengths of the parasitic element 22 in the Y and Z axis directions: 10 mm and 190 m, respectively.

Distance between the switch 222 and the switch 222 in Z-axis direction: 5 mm.

Distance between the antenna 20 and the parasitic element 21 in Y-axis direction: 75 mm.

Distance between the antenna 20 and the parasitic element 22 in Y-axis direction: 75 mm.

Lengths of the divided base plate 31 in the Y and Z axis directions: 250 mm and 45 mm, respectively.

Lengths of the divided base plate 32 in the Y and Z axis directions: 250 mm and 200 mm, respectively.

Distance between the divided base plate 31 and divided base plate 32 in the Z-axis direction: 5 mm.

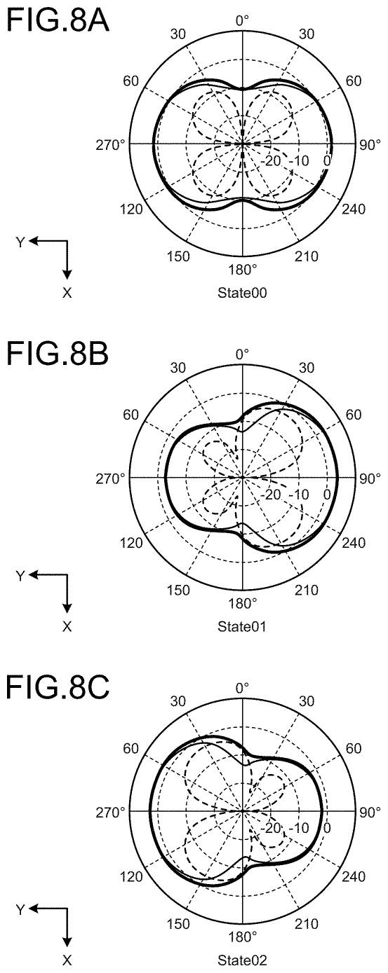

FIGS. 8A to 8C illustrate simulation results regarding State 00 to State 02. The solid line indicates the gain (dBi) of the vertically polarized wave, the broken line indicates the gain of the horizontally polarized wave, and the thick solid line indicates the total gain (dBi). In State 00 to State 02, radiation of the vertically polarized wave in the Y-axis direction is dominant. This is because the antenna 10, the parasitic element 11, and the parasitic element 12, which are conductive members, are provided side by side in the Y-axis direction.

In State 00 (FIG. 8A), directivity that is substantially symmetric in the X-axis direction and the Y-axis direction is obtained. This is because the parasitic element 11 and the parasitic element 12 are both separated from the divided base plate 31 by the switch 111 and the switch 121 respectively, and thus the effect of the parasitic element 11 and the parasitic element 12 on the antenna 10 is small.

In State 01 (FIG. 8B), the gain in the Y-axis negative direction is larger compared to State 00 (FIG. 8A). This is because, only the parasitic element 11, among the parasitic element 11 and the parasitic element 12, is connected to the divided base plate 31 by the switch 111, causing the parasitic element 11 to operate as a reflective element.

In State 02 (FIG. 8C), the gain in the Y-axis positive direction is larger compared to State 00 (FIG. 8A). This is because, only the parasitic element 12, among the parasitic element 11 and the parasitic element 12, is connected to the divided base plate 31 by the switch 121, causing the parasitic element 12 to operate as a reflective element.

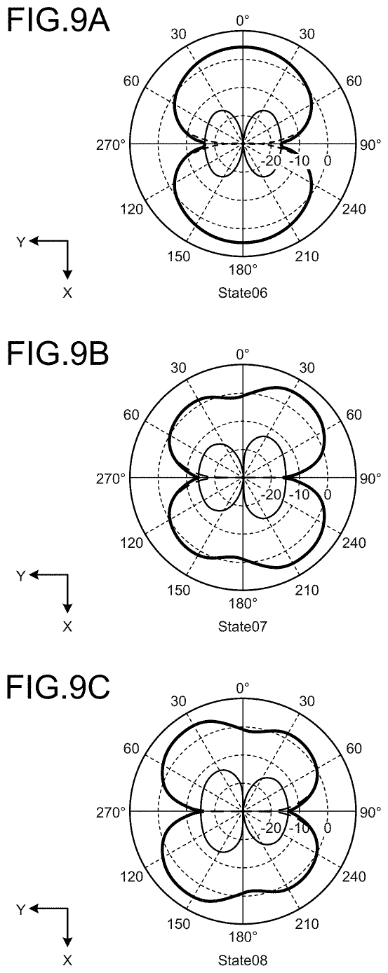

FIGS. 9A to 9C illustrate simulation results regarding State 06 to State 08. The solid line indicates the gain (dBi) of the vertically polarized wave, the broken line indicates the gain of the horizontally polarized wave, and the thick solid line indicates the total gain (dBi). In State 06 to State 08, radiation of the horizontally polarized wave in the X-axis direction is dominant. This is because the antenna 20 being a slot line, the parasitic element 21, and the parasitic element 22 are provided side by side in the Y-axis direction.

In State 06 (FIG. 9A), directivity that is substantially symmetric in the X-axis direction and the Y-axis direction is obtained. This is because the line lengths of the parasitic element 21 and the parasitic element 22 have not been changed by the switch 211, the switch 212, the switch 221, or the switch 222, and thus, the effect of the parasitic element 21 and the parasitic element 22 on the antenna 20 is small.

In State 07 (FIG. 9B), the gain in the Y-axis negative direction is large. This is because, only the line length of the parasitic element 21, among the line lengths of the parasitic element 21 and the parasitic element 22, has been changed to be short by the switch 211 and the switch 212, causing the parasitic element 22 to operate as a reflective element.

In State 08 (FIG. 9C), the gain in the positive direction on the Y-axis is large. This is because, only the line length of the parasitic element 22, among the line lengths of the parasitic element 21 and the parasitic element 22, has been changed to be short by the switch 221 and the switch 222, causing the parasitic element 21 to operate as a reflective element.

State 00 to State 02 and State 06 to State 08 described above are examples of switching polarization by switching between the antenna 10 and the antenna 20, and control of directivity by switching between the switch 111, the switch 121, the switch 211, the switch 212, the switch 221, and the switch 222. In addition, a person skilled in the art can understand that directivity is also controlled by switching the switches 301 to 308.

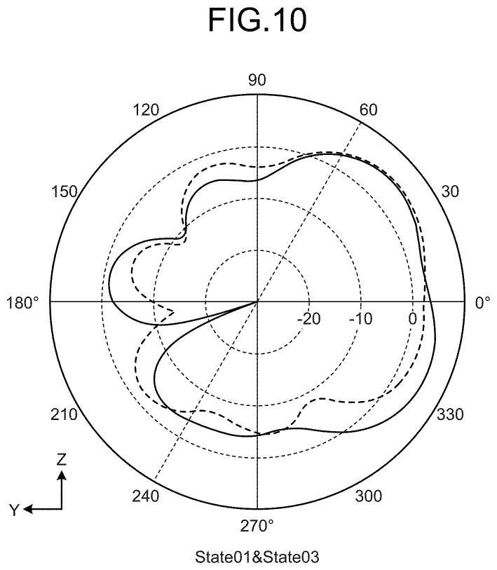

FIG. 10 illustrates a comparison between State 01 and State 03. A solid line indicates the total gain (dBi) of State 1, while a broken line indicates the total gain (dBi) of State 03. State 03 can achieve the directivity different from the directivity of State 01. This is because State 03 has a change in the pattern of the base plate 30 due to the connection of the divided base plate 31 and the divided base plate 32 by the switches 301 to 308, leading to the change in the current flowing through the base plate 30 and the divided base plate 31.

As described above, the antenna device 1 can have various States of different polarizations and different directivities. The State of the antenna device 1 is controlled by the switching control block 500 described above with reference to FIG. 6.

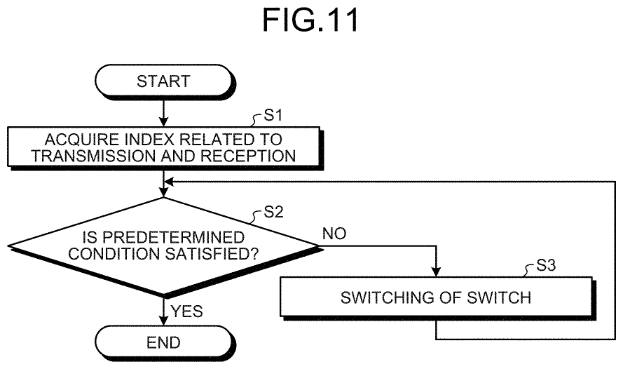

FIG. 11 is a flowchart illustrating an example of switching control processing (a method of controlling the antenna device 1). This processing is repeatedly executed by the switching control block 500, during execution of transmission and reception (use of the electronic device 5) by the antenna device 1, for example.

In Step S1, the switching control block 500 acquires an index related to transmission and reception. For example, as described above with reference to FIG. 6, the indexes acquired include the reception level information (RSSI), the transmission level information, the reception QoS information (SIR, BER), and the transmission QoS information.

In Step S2, the switching control block 500 determines whether a predetermined condition is satisfied. For example, in a case of searching for a State in which the best index is obtained, it is allowable to determine that the predetermined condition is satisfied when the index acquired in the later Step S1 is better than the index acquired in the previous loop Step S1. Alternatively, if a State that satisfies a certain degree of index is sufficient, it is allowable to determine that the predetermined condition is satisfied in a case where the index acquired in the later Step S1 exceeds the threshold. In addition, various conditions may be used as the predetermined conditions. When the predetermined condition is satisfied (Yes in Step S2), the processing of the flowchart ends. When the predetermined condition is not satisfied (No in Step S2), the processing returns to Step S1 via Step S3.

In Step S3, the switching control block 500 switches the switch. Which switch is to be switched may be appropriately determined. For example, each switch may be switched so as to implement State 00 to State 23 described above sequentially every time Steps S1 to S3 are looped.

For example, as described above, the antenna device 1 can be switched to a State capable of obtaining desired directivity.

### 1.6 Modification

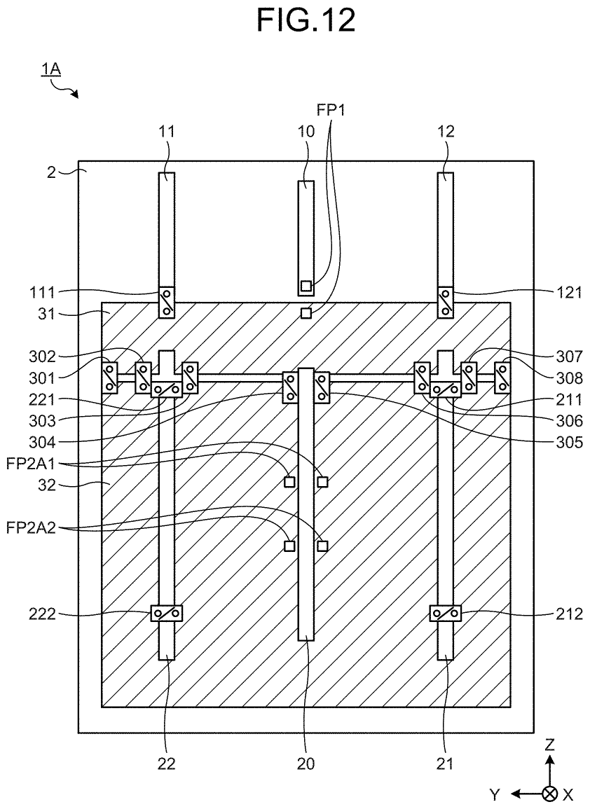

Some modifications of the antenna device 1 will be described with reference to FIGS. 12 to 18.

For example, feeding points may be provided at a plurality of positions in the antenna. FIG. 12 is a plan view illustrating a schematic configuration of an antenna device according to such a modification. An antenna device 1A illustrated in FIG. 12 is different from the antenna device 1 (FIG. 2) in that the position of the feeding point of the antenna 20 is different. In this example, two feeding points FP2A1 and FP2A2 are provided at certain positions of the antenna 20. The number and positions of the feeding points FP2A1 and FP2A2 are examples, and various other feeding points may be provided at various positions. By changing the feeding position of the antenna 20, it is possible to obtain different directivities according to a change in the length or the like of the antenna 20.

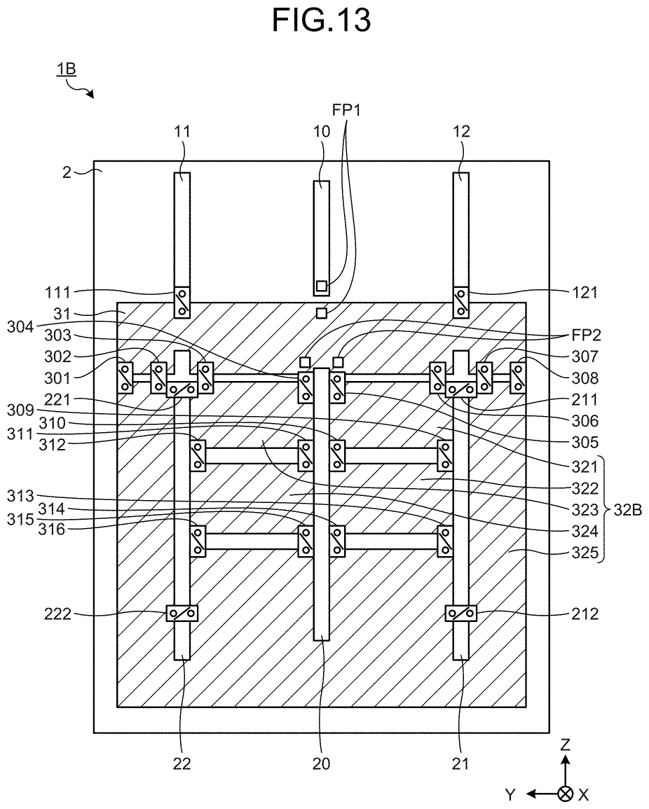

For example, the base plate may be further divided. FIG. 13 is a plan view illustrating a schematic configuration of an antenna device according to such a modification. An antenna device 1B illustrated in FIG. 13 is different from the antenna device 1 (FIG. 2) in that it includes a divided base plate 32B in place of the divided base plate 32, and includes switches 309 to 316. The divided base plate 32B is divided into five portions, namely, a first portion 321, a second portion 322, a third portion 323, a fourth portion 324, and a fifth portion 325. Each portion is connected to each other by switches 309 to 316.

The first portion 321 and the second portion 322 are provided between the antenna 20 and the parasitic element 21 sequentially from the base end toward the tip end of the antenna 20 (in the Z-axis negative direction). In this example, the first portion 321 and the second portion 322 have a substantially rectangular shape. The switch 309 is connected between the first portion 321 and the second portion 322 in the vicinity of the parasitic element 21. The switch 310 is connected between the first portion 321 and the second portion 322 in the vicinity of the antenna 20.

The third portion 323 and the fourth portion 324 are sequentially provided between the antenna 20 and the parasitic element 22 in a direction from the base end toward the tip end of the antenna 20. In this example, the third portion 323 and the fourth portion 324 have a substantially rectangular shape. The switch 311 is connected between the third portion 323 and the fourth portion 324 in the vicinity of the antenna 20. The switch 312 is connected between the third portion 323 and the fourth portion 324 in the vicinity of the parasitic element 22.

Fifth portion 325 is a portion other than the first portion 321 to the fourth portion 324 in the divided base plate 32. In the fifth portion 325, a portion provided between the antenna 20 and the parasitic element 21 is connected to the second portion 322 via the switch 313 and the switch 314. The switch 313 is connected between the second portion 322 and the fifth portion 325 in the vicinity of the parasitic element 21. The switch 314 is connected between the second portion 322 and the fifth portion 325 in the vicinity of the antenna 20. In the fifth portion 325, a portion provided between the antenna 20 and the parasitic element 22 is connected to the fourth portion 324 via the switch 315 and the switch 316. The switch 315 is connected between the fourth portion 324 and the fifth portion 325 in the vicinity of the parasitic element 22. The switch 316 is connected between the fourth portion 324 and the fifth portion 325 in the vicinity of the parasitic element 22.

The switches 309 to 316 are switched by the switching control block 500 (FIG. 6). By switching the switches 309 to 316, the pattern of the divided base plate 32B is changed, leading to acquisition of different directivities. Note that the division pattern and the connection relationship of the divided base plate 32B are not limited to the example illustrated in FIG. 13.

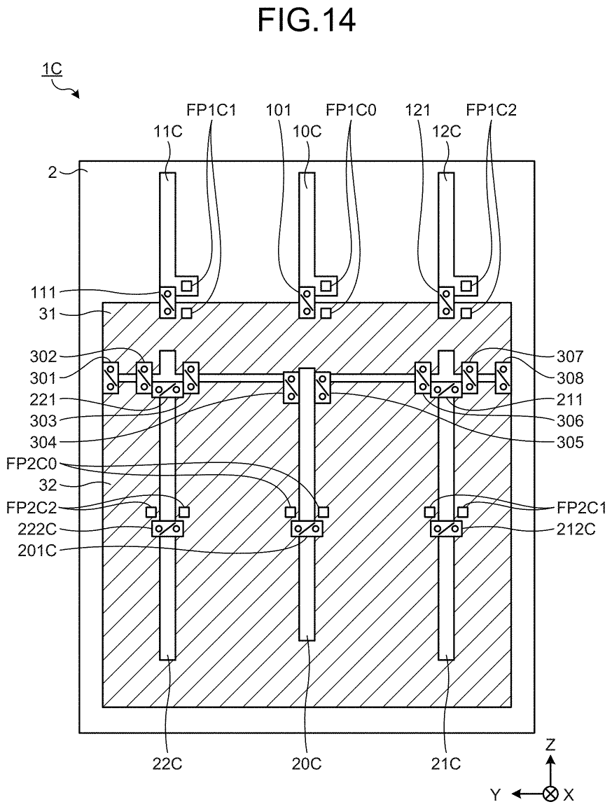

In addition, for example, the antenna and the parasitic element may be functionally switched between each other, and furthermore, a feeding point may be provided at any position of the antenna. FIG. 14 is a plan view illustrating a schematic configuration of an antenna device according to such a modification. An antenna device 1C illustrated in FIG. 14 is different from the antenna device 1 (FIG. 2) in that it includes an antenna 10C, a parasitic element 11C, a parasitic element 12C, an antenna 20C, a parasitic element 21C, a parasitic element 22C, a switch 201C, a switch 212C, and a switch 222C in place of the antenna 10, the parasitic element 11, the parasitic element 12, the antenna 20, the parasitic element 21, the parasitic element 22, the switch 212, and the switch 222.

The antenna 10C is different from the antenna 10 (FIG. 2) in that the antenna 10C includes a switch 101 and a feeding point FP1C0 at the base end. The switch 101 is provided in parallel to the feeding point FP1C0. The switch 101 is switched by the switching control block 500 (FIG. 6). With the switch 101 set to SHORT, the antenna 10C can be used as a parasitic element instead of exciting the antenna 10C via the feeding point FP1C0.

The parasitic element 11C is different from the parasitic element 11 (FIG. 2) in that a feeding point FP1C1 is provided at the base end. In this case, the switch 111 is provided in parallel to the feeding point FP1C1. With the switch 111 set to OPEN, the parasitic element 11C is excited via the feeding point FP1C1, and the parasitic element 11C can be used as an antenna.

The parasitic element 12C is different from the parasitic element 12 (FIG. 2) in that a feeding point FP1C2 is provided at the base end. In this case, the switch 121 is provided in parallel to the feeding point FP1C2. With the switch 121 set to OPEN, the parasitic element 12C is excited via the feeding point FP1C2, and the parasitic element 12C can be used as an antenna.

The antenna 20C is different from the antenna 20 (FIG. 2) in that a feeding point FP2C0 is provided instead of the feeding point FP2. The feeding point FP2C0 is provided at any position of the antenna 20, not limited to the base end of the antenna 20. The switch 201C is connected in parallel to the feeding point FP2C0. That is, the switch 201C is connected between the divided base plates 32 at both ends of the antenna 20C. The switch 201C is switched by the switching control block 500 (FIG. 6). With the switch 201C set to SHORT, the antenna 20C can be used as a parasitic element instead of exciting the antenna 20C via the feeding point FP2C1.

The parasitic element 21C is different from the parasitic element 21 (FIG. 2) in that it includes a feeding point FP2C1 and includes a switch 212C in place of the switch 212. The feeding point FP2C1 is provided at any position of the parasitic element 21C. The switch 212C is connected in parallel to the feeding point FP2C1. That is, the switch 212C is connected between the divided base plates 32 at both ends of the parasitic element 21. The switch 212C is switched by the switching control block 500 (FIG. 6). With the switch 212C set to OPEN, the parasitic element 21C is excited via the feeding point FP2C1, and the parasitic element 21C can be used as an antenna.

The parasitic element 22C is different from the parasitic element 22 (FIG. 2) in that it includes a feeding point FP2C2 and includes a switch 222C in place of the switch 222. The feeding point FP2C2 is provided at any position of the parasitic element 22C. The switch 222C is connected in parallel to the feeding point FP2C2. That is, the switch 222C is connected between the divided base plates 32 at both ends of the parasitic element 22C. The switch 222C is switched by the switching control block 500 (FIG. 6). With the switch 222C set to OPEN, the parasitic element 22C is excited via the feeding point FP2C2, and the parasitic element 22C can be used as an antenna.

Different directivities can be obtained by functionally switching the antenna and the parasitic element in the antenna 10C, the parasitic element 11C, and the parasitic element 12, and further by functionally switching the antenna and the parasitic element in the antenna 20C, the parasitic element 21C, and the parasitic element 22C or changing the position of the feeding point.

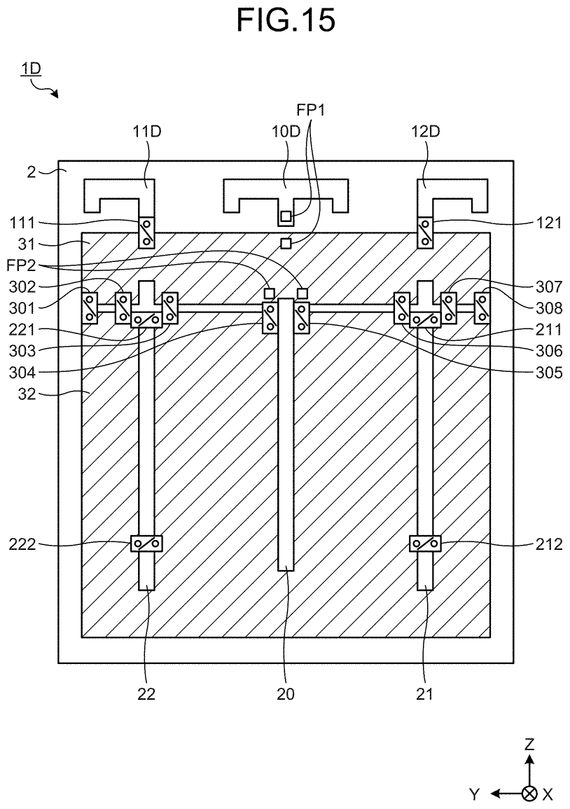

In addition, for example, the antenna may have various shapes other than a linear rectangular shape. FIG. 15 is a plan view illustrating a schematic configuration of an antenna device according to such a modification. An antenna device 1D illustrated in FIG. 15 is different from the antenna device 1 (FIG. 2) in that the antenna device 1D includes an antenna 10D, a parasitic element 11D, and a parasitic element 12D instead of the antenna 10, the parasitic element 11, and the parasitic element 12, respectively.

The antenna 10D is different from the antenna 10 (FIG. 2) in that it is a bent antenna having a bent portion. In the example illustrated in FIG. 14, the antenna 10D includes a portion extending in the Z-axis positive direction from the base end, two portions bent therefrom and extending in the Y-axis positive and negative directions, and a portion further bent therefrom and extending in the Z-axis negative direction. The parasitic element 11D has a portion extending in the Z-axis positive direction from the base end, a portion bent therefrom and extending in the Y-axis positive direction, and a portion further bent therefrom and extending in the Z-axis negative direction. The parasitic element 12D has a portion extending in the Z-axis positive direction from the base end, a portion bent therefrom and extending in the Y-axis negative direction, and a portion further bent therefrom and extending in the Z-axis negative direction.

Different directivities can be obtained according to the bent shapes of the antenna 10D, the parasitic element 11D, and the parasitic element 12D. In addition, forming the antenna device 1D to have a bent shape, it is possible to downsize the antenna device 1D compared to the antenna device 1. Note that the shapes of the antenna 10D, the parasitic element 11D, and the parasitic element 12D are not limited to the example illustrated in FIG. 15 as long as the lengths of each antenna in the Z-axis direction can be reduced. For example, the antenna 10D may have a curved portion instead of the bent portion, or may have both a bent portion and a curved portion.

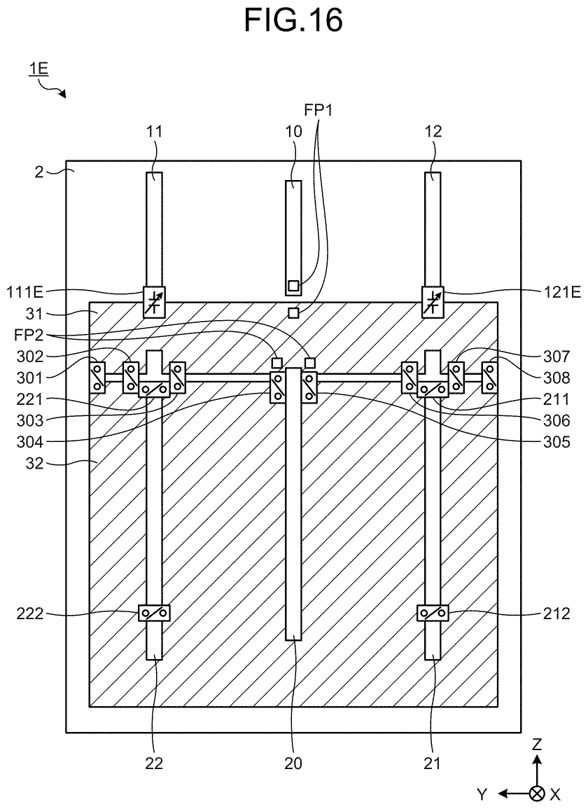

In addition, for example, a variable reactance element may be provided for the parasitic element. FIG. 16 is a plan view illustrating a schematic configuration of an antenna device according to such a modification. An antenna device 1E illustrated in FIG. 16 is different from antenna device 1 (FIG. 2) in that the antenna device 1E includes variable reactance element 111E and variable reactance element 121E in place of the switch 111 and the switch 121, respectively. The variable reactance element 111E and the variable reactance element 121E are one aspect of switches constituting a switch group.

The variable reactance element 111E and the variable reactance element 121E exemplified are capacitors capable of changing a capacitance value such as a variable capacitance (varicap) diode. The capacitance values of the variable reactance element 111E and the variable reactance element 121E are controlled by the switching control block 500 (FIG. 6).

Different directivities can be obtained also by changing the reactance values of the variable reactance element 111E and the variable reactance element 121E to switch the connection state between the parasitic element 11 and the divided base plate 31.

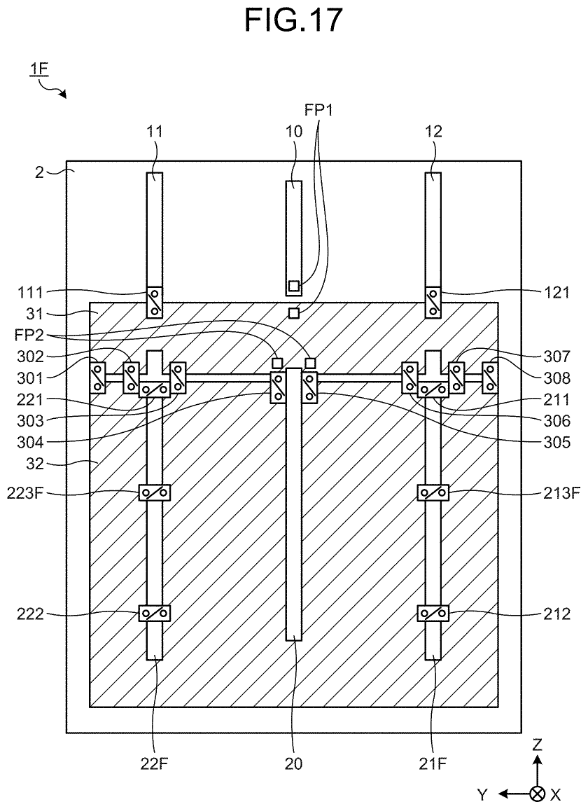

Furthermore, for example, it is also allowable to enable the switch to further finely change the length of the parasitic element. FIG. 17 is a plan view illustrating a schematic configuration of an antenna device according to such a modification. An antenna device 1F illustrated in FIG. 17 is different from the antenna device 1 (FIG. 2) in that the antenna device 1F includes a parasitic element 21F and a parasitic element 22F in place of the parasitic element 21 and the parasitic element 22, respectively, and further includes a switch 213F and a switch 223F.

The switch 213F is provided at a certain position between the switch 211 and the switch 212 in the parasitic element 21F. The switch 213F is connected across the divided base plates 32 on both sides of the parasitic element 21F. When the switch 211 is set to OPNE and the switch 213F is SHORT, the parasitic element 21 has a line length ranging from the base end to the switch 214.

The switch 223F is provided at a certain position between the switch 221 and the switch 222 in the parasitic element 22F. The switch 223F is connected across the divided base plates 32 on both sides of the parasitic element 22. When the switch 221 is set to OPEN and the switch 223F is SHORT, the parasitic element 22 has a line length ranging from the base end to the switch 224.

Different directivities can be obtained by further finely switching the lengths of the parasitic element 21F and the parasitic element 22F by the switch 213F and the switch 223F. Note that another switch may be provided in addition to the switch 213F and the switch 223F.

In addition, for example, the radiation pattern can be freely changed by various combinations other than those described above, such as a combination of excitation in the vertically polarized wave and parasitic elements in the horizontally polarized wave, making it possible to further optimize the communication performance. It is also possible to form each of elements to function as a multiband element. It is also possible to use an antenna tuning element to achieve a broadband.

### 2. Second Embodiment

### 2.1 Example of Schematic Configuration of Antenna Device

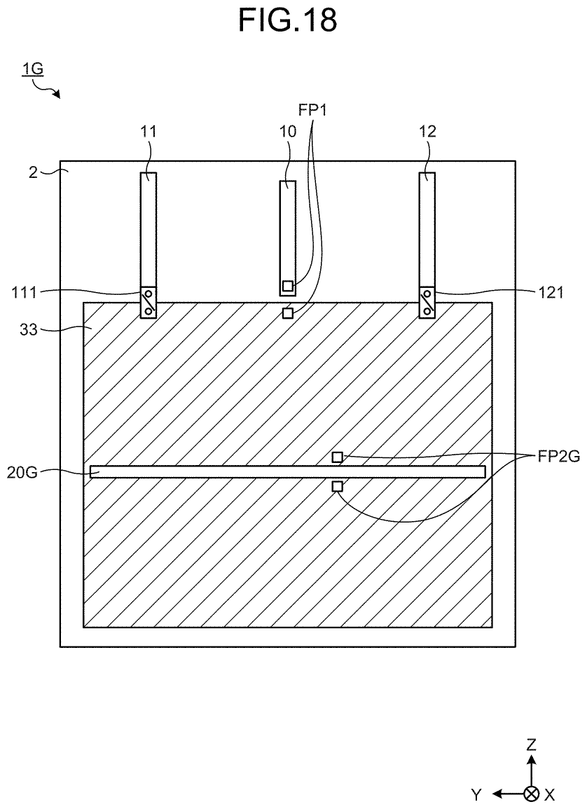

FIG. 18 is a view illustrating an example of a schematic configuration of an antenna device according to a second embodiment. An antenna device 1G illustrated in FIG. 18 is different from antenna device 1 (FIG. 2) in that the antenna device 1G includes an antenna 20G and a base plate 33 in place of the antenna 20 and the base plate 30, respectively. Although the antenna device 1G is illustrated in a mode not including the parasitic element 21 or the parasitic element 22 as in the antenna device 1 (FIG. 2), the antenna device 1G may include configurations corresponding to the parasitic element 21 and the parasitic element 22.

The antenna 20G is a second antenna provided on the substrate 2 so as to radiate the second polarized wave. The second polarized wave radiated by the antenna 20G is a polarized wave in the same direction as the first polarized wave radiated by the antenna 10. The antenna 20G illustrated in FIG. 18 is a slot antenna provided on the substrate 2 so as to extend in the horizontal direction, and radiates a vertically polarized wave. A feeding point FP2G of the antenna 20 G may be provided at any position of the antenna 20G. The base plate 33 is provided on the substrate 2 so as to have an area (pattern length and pattern width) capable of having an effect on the radiation characteristics of the antenna 10 and/or 20G. In this example, the base plate 33 has a substantially rectangular shape except for a portion where the antenna 20G exists. The base plate 33 has a length (length in the Y-axis direction) capable of forming the antenna 20G. The antenna 20G is excited via the feeding point FP2G.

The antenna device 1G also has various States as described below by the switching control block 500 (FIG. 6).

### 2.2 Example of States

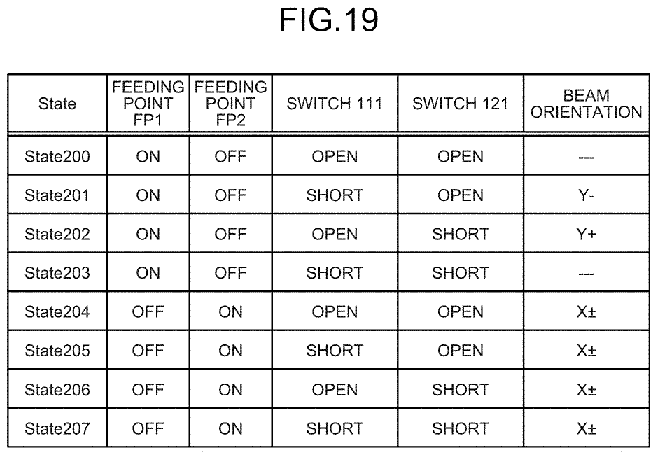

FIG. 19 is a diagram illustrating an example of States. The “beam direction” indicates orientation of directivity. “Y−” corresponds to the Y-axis negative direction. “Y+” corresponds to the Y-axis positive direction. “X±” corresponds to the X-axis positive direction and the X-axis negative direction. According to the antenna device 1G, eight State patterns of State 200 to State 207 are obtained.

### 2.3 Simulation Result

Directivity simulation has been performed on the antenna device 1G (FIG. 18) described above. Main simulation conditions are as follows.

Frequency: 700 MHz to 1 GHz

The lengths of the substrate 2 in the X, Y, and Z axis directions are 0.36 mm, 210 mm, and 218 mm, respectively.

Relative permittivity of substrate 2: 4.6.

Thickness and conductivity of a conductive member (metal pattern) provided on the substrate 2: 0.02 mm and 5.8×10⁷S/m, respectively.

Lengths of the antenna 10 in the Y and Z axis directions: 2 mm and 67 mm, respectively.

The lengths of the parasitic element 11 in the Y and Z axis directions: 2 mm and 67 mm, respectively.

The lengths of the parasitic element 12 in the Y and Z axis directions: 2 mm and 67 mm, respectively.

Distance between the antenna 10 and the parasitic element 11 in Y-axis direction: 88 mm.

Distance between the antenna 10 and the parasitic element 12 in Y-axis direction: 88 mm.

Lengths of the antenna 20 in Y and Z axis directions (of slot): 200 and 4 mm, respectively.

Distance from one end of the antenna 20 to the feeding point FP2G in the Y-axis direction: 60 mm.

Length of the base plate 33 in each of Y and Z axis directions: 209 mm and 150 mm, respectively.

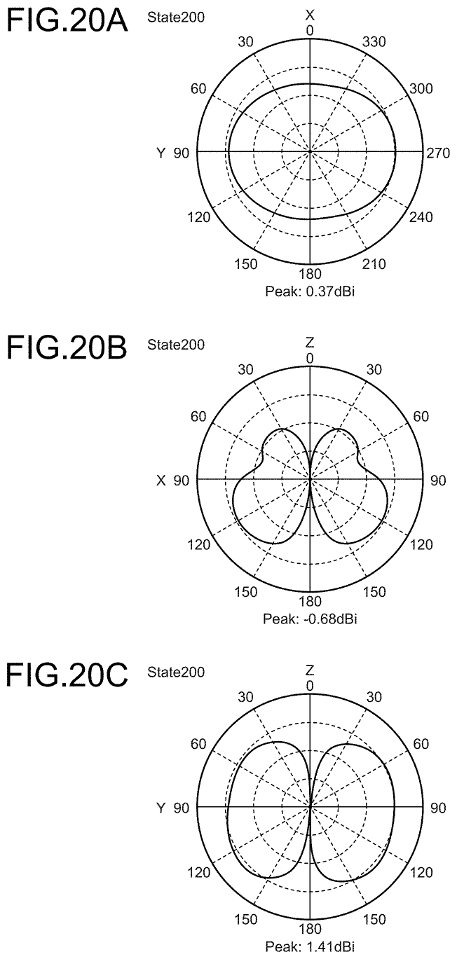

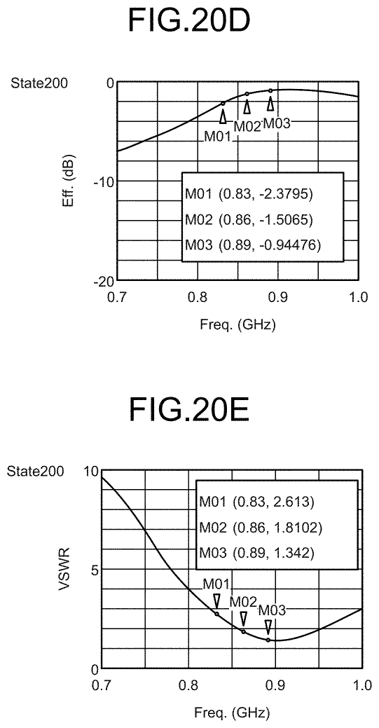

FIGS. 20A to 20E illustrate simulation results regarding State 200. FIGS. 20A to 20C respectively illustrate directivities when viewed on the XY plane, the XZ plane, and the YZ plane. In State 200, directivity is obtained particularly in the Y-axis direction. This is because the antenna 10, the parasitic element 11, and the parasitic element 12, which are conductive members, are provided side by side in the Y-axis direction. Moreover, directivity that is substantially symmetric in the X-axis direction and the Y-axis direction is obtained. This is because the parasitic element 11 and the parasitic element 12 are both separated from the base plate 33 by the switch 111 and the switch 121 respectively, and thus the effect of the parasitic element 11 and the parasitic element 12 on the antenna 10 is small. FIG. 20D illustrates radiation efficiency (dB) and FIG. 20E illustrates VSWR. A marker M01, a marker M02, and a marker M03 correspond to frequencies=0.83 GHz, 0.86 GHz, and 0.89 GHz, respectively. As indicated by the markers M01 to M03, favorable radiation efficiency and VSWR have been obtained in a frequency range 0.83 GHz to 0.89 GHz.

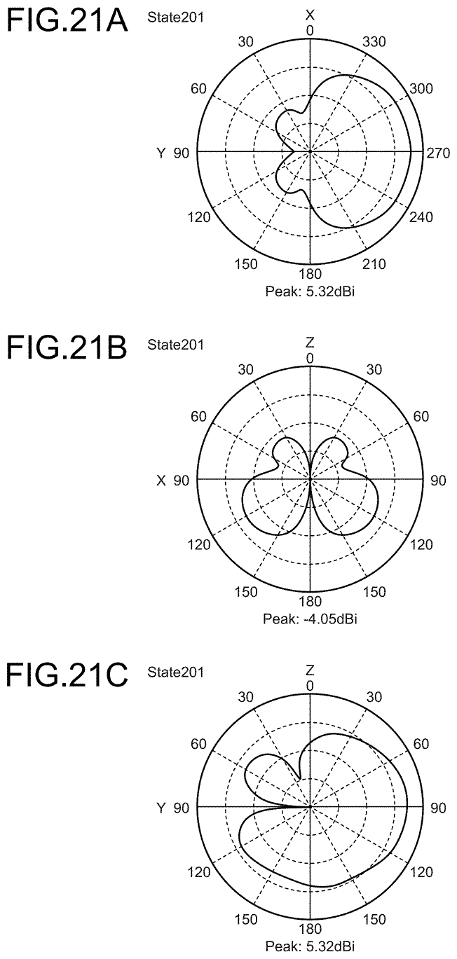

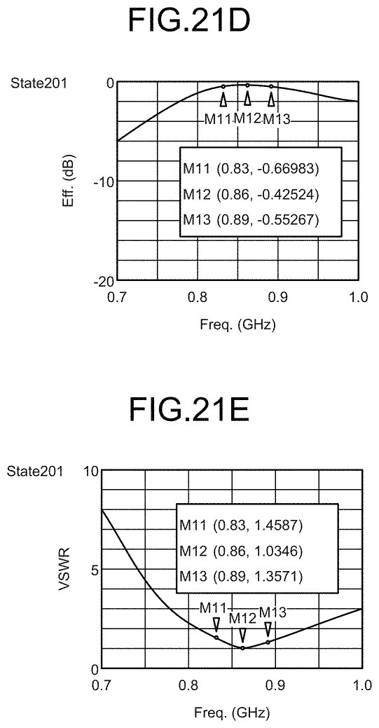

FIGS. 21A to 21E illustrate simulation results regarding State 201. As illustrated in FIGS. 21A to 21C, in State 201, the gain in the Y-axis negative direction is larger compared to State 200 (FIGS. 20A to 20C). This is because, only the parasitic element 11, among the parasitic element 11 and the parasitic element 12, is connected to the divided base plate 33 by the switch 111, causing the parasitic element 11 to operate as a reflective element. Even in this case, as indicated by the markers M11 to M13 in FIGS. 21D and 21E, favorable radiation efficiency and VSWR are still obtained in a frequency range 0.83 GHz to 0.89 GHz.

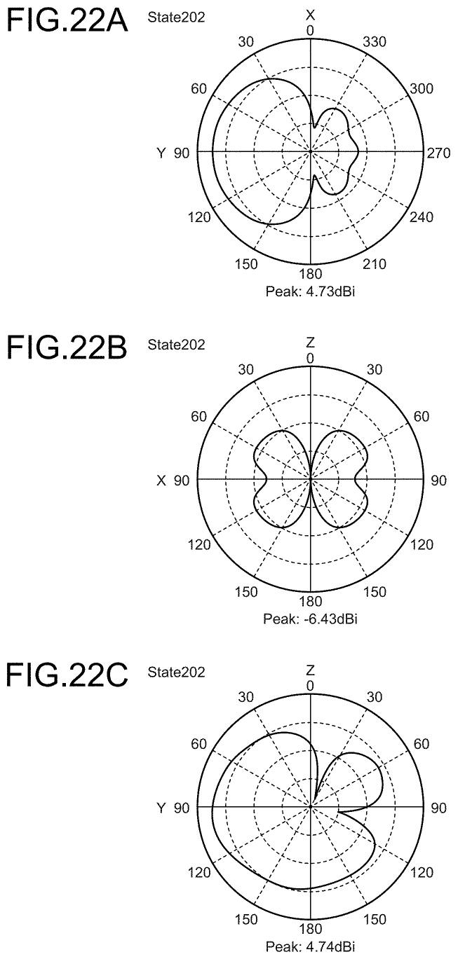

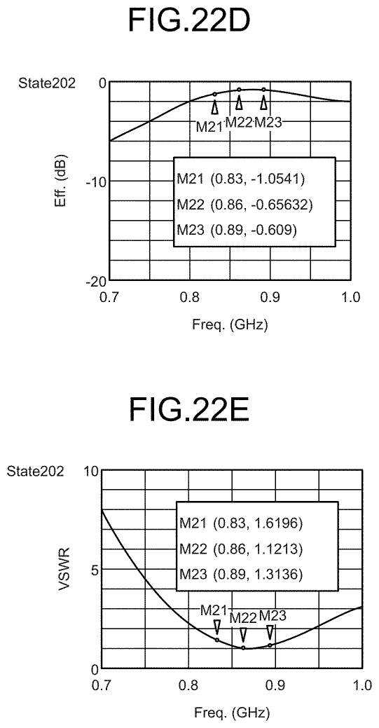

FIGS. 22A to 22E illustrate simulation results of State 202. As illustrated in FIGS. 22A to 22C, in State 202, the gain in the Y-axis positive direction is larger compared to State 200 (FIGS. 20A to 20C). This is because, only the parasitic element 12, among the parasitic element 11 and the parasitic element 12, is connected to the divided base plate 33 by the switch 121, causing the parasitic element 12 to operate as a reflective element. Even in this case, as indicated by the markers M21 to M23 in FIGS. 22D and 22E, favorable radiation efficiency and VSWR are still obtained at the frequency range 0.83 GHz to 0.89 GHz.

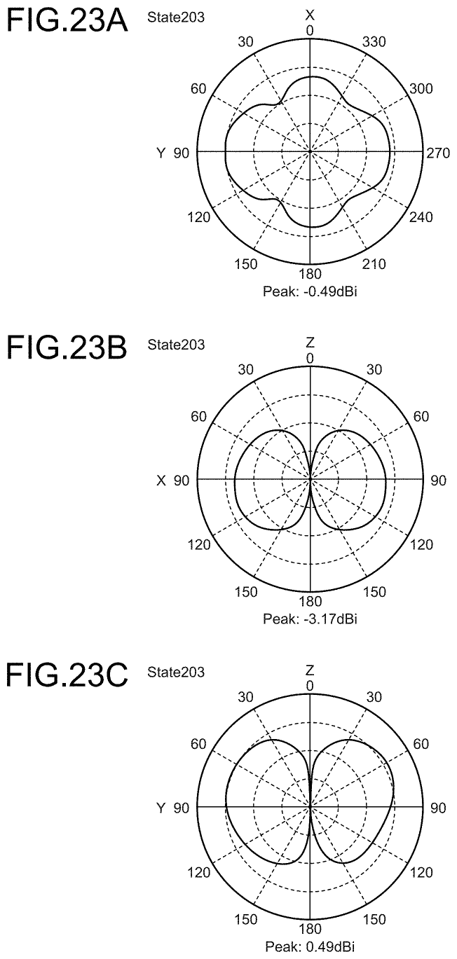

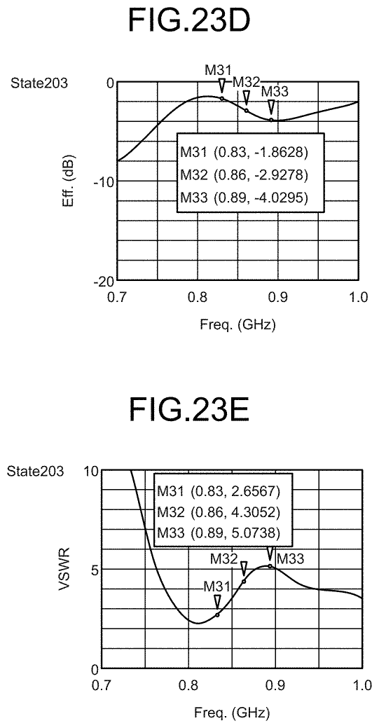

FIGS. 23A to 23E illustrate simulation results of State 203. As illustrated in FIGS. 23A to 23C, in State 203, the gain in the X-axis direction and the Y-axis positive direction changes as compared to State 200 (FIGS. 20A to 20C). This is considered to be caused by the change in the effect of the parasitic element 11 and the parasitic element 12 on the antenna 10 due to the connection of the parasitic element 11 and the parasitic element 12 to the base plate 33 respectively by the switch 111 and the switch 121. As indicated by the markers M31 to M33 in FIGS. 23D and 23E, the radiation efficiency and the VSWR also change at a frequency range of 0.83 GHz to 0.89 GHz.

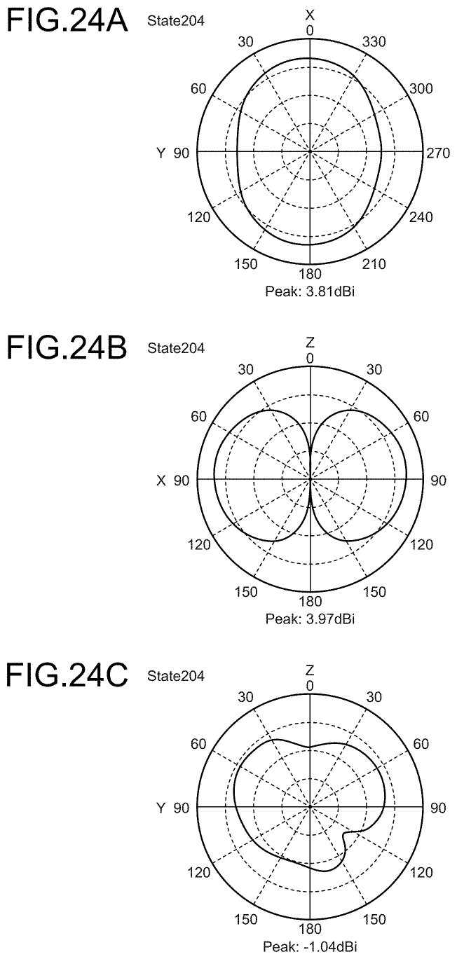

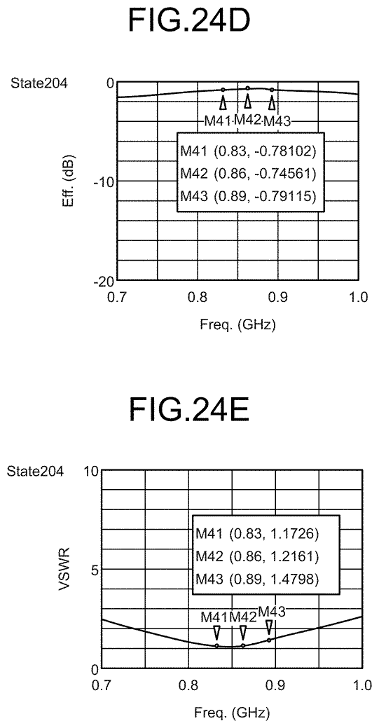

FIGS. 24A to 24E illustrate simulation results of State 204. As illustrated in FIGS. 24A to 24C, in State 204, directivity is obtained particularly in the X-axis direction. This is because the antenna 20 G, which is a slot line, is provided in the Y-axis direction. Moreover, directivity that is substantially symmetric in the X-axis direction and the Y-axis direction is obtained. This is because the base plate 33 is separated from the parasitic element 11 and the parasitic element 12 by the switch 111 and the switch 121 respectively, and thus the effect of the parasitic element 11 and the parasitic element 12 on the antenna 20G is small. As indicated by the markers M41 to M43, favorable radiation efficiency and VSWR are still obtained in a frequency range 0.83 GHz to 0.89 GHz.

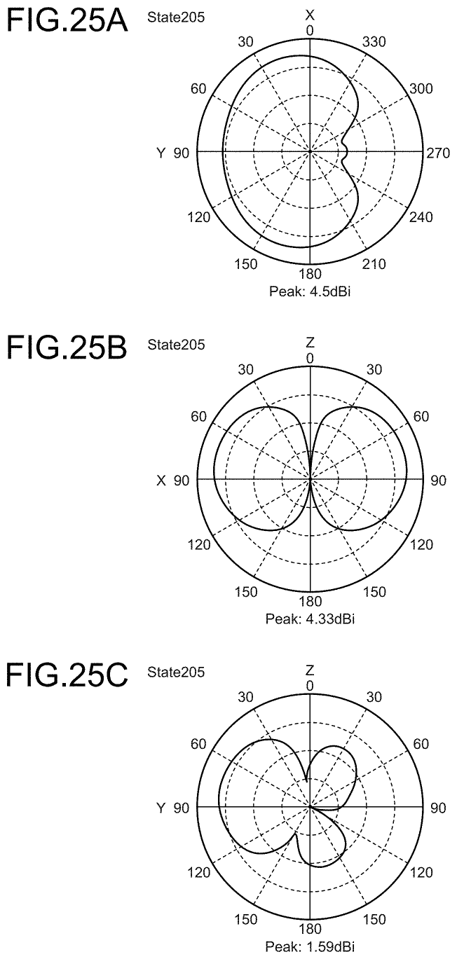

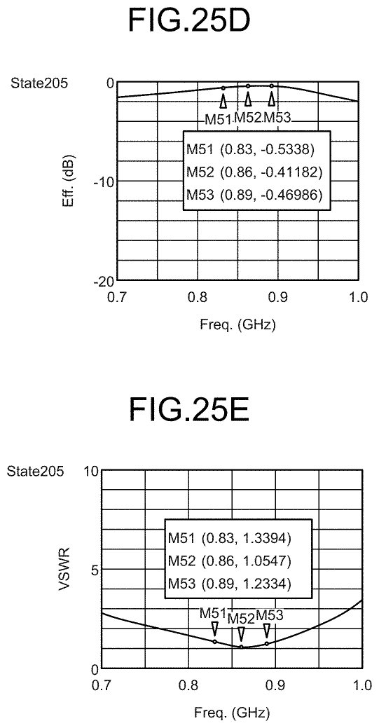

FIGS. 25A to 25E illustrate simulation results of State 205. As illustrated in FIGS. 25A to 25C, in State 205, the gain in the Y-axis positive direction is larger compared to State 204 (FIGS. 24A to 24C). This is considered to be caused by the change in the effect of the parasitic element 11 on the antenna 20G due to the state where the base plate 33 is connected to the parasitic element 11 by the switch 111. As indicated by the markers M51 to M53, favorable radiation efficiency and VSWR are still obtained in a frequency range 0.83 GHz to 0.89 GHz.

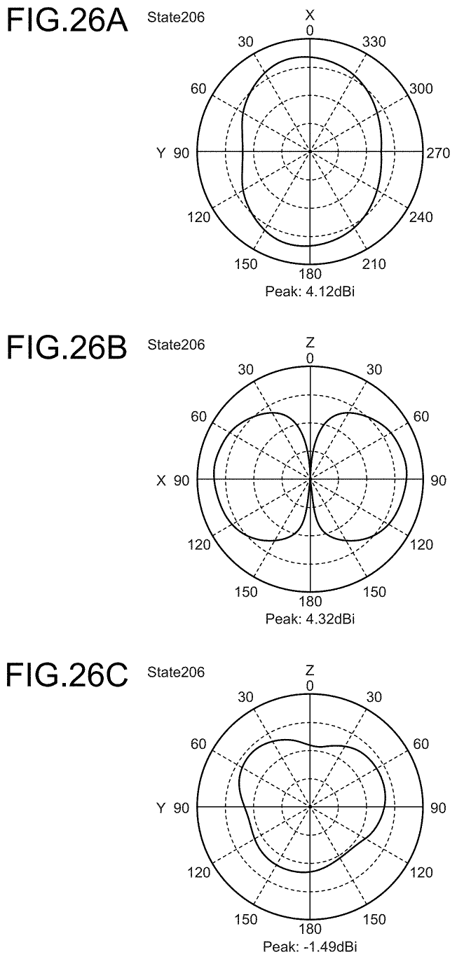

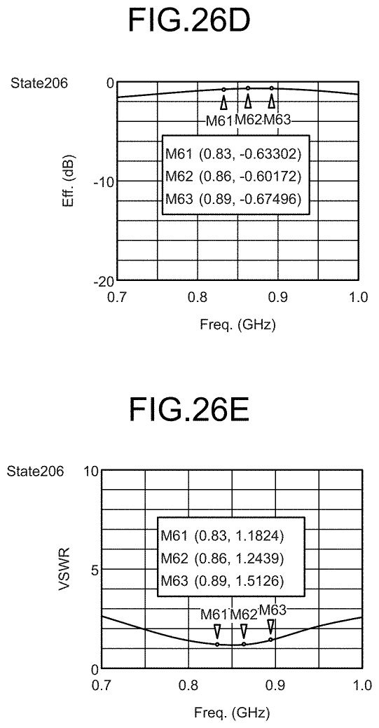

FIGS. 26A to 26E illustrate simulation results of State 206. As illustrated in FIGS. 26A to 26C, in State 206, the gain in the X-axis direction and the Y-axis direction changes as compared to State 204 (FIGS. 24A to 24C). This is considered to be caused by the change in the effect of the parasitic element 12 on the antenna 20G due to the state where the base plate 33 is connected to the parasitic element 12 by the switch 121. As indicated by the markers M61 to M63, favorable radiation efficiency and VSWR are still obtained in a frequency range 0.83 GHz to 0.89 GHz.

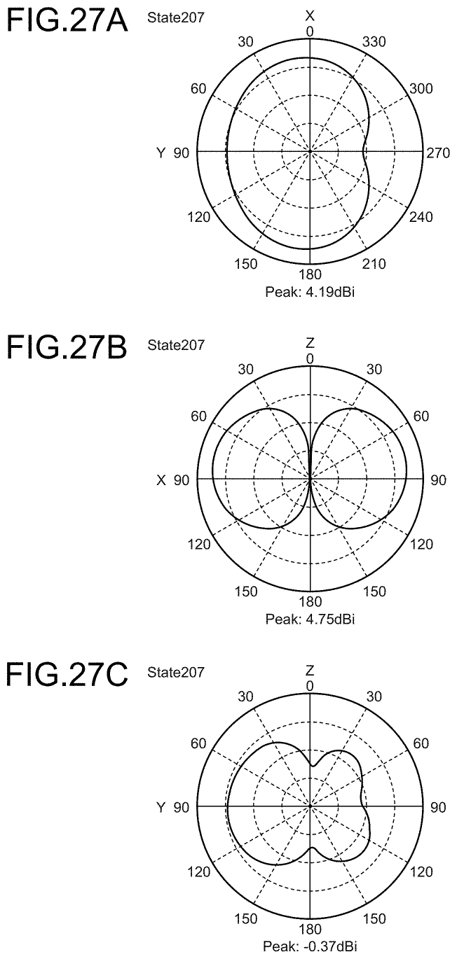

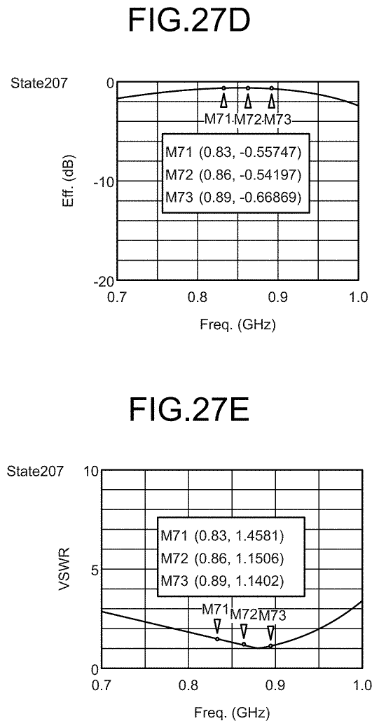

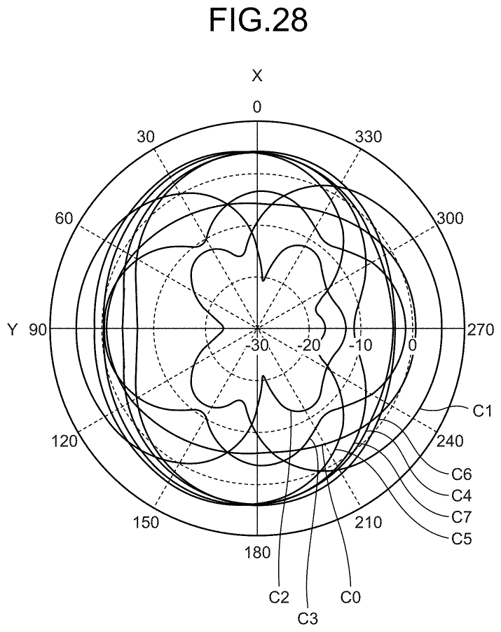

FIGS. 27A to 27E illustrate simulation results of State 207. As illustrated in FIGS. 27A to 27C, in State 207, the gain in the Y-axis positive direction is larger compared to State 204 (FIGS. 24A to 24C). This is considered to be caused by the change in the effect of the parasitic element 11 and the parasitic element 12 on the antenna 20G due to the connection of the base plate 33 to the parasitic element 11 and the parasitic element 12 by the switch 111 and the switch 121. As indicated by the markers M71 to M73, favorable radiation efficiency and VSWR are still obtained in a frequency range 0.83 GHz to 0.89 GHz.

FIG. 28 illustrates a comparison between State 200 and State 207. A curve C0 to a curve C7 indicate gains of State 200 to State 207, respectively. As illustrated in FIG. 28, when viewed in the XY plane, for example, a gain up to 5 dBi is obtained in all directions of 360 degrees by switching between State 200 to State 207.

### 2.4 Experimental Results

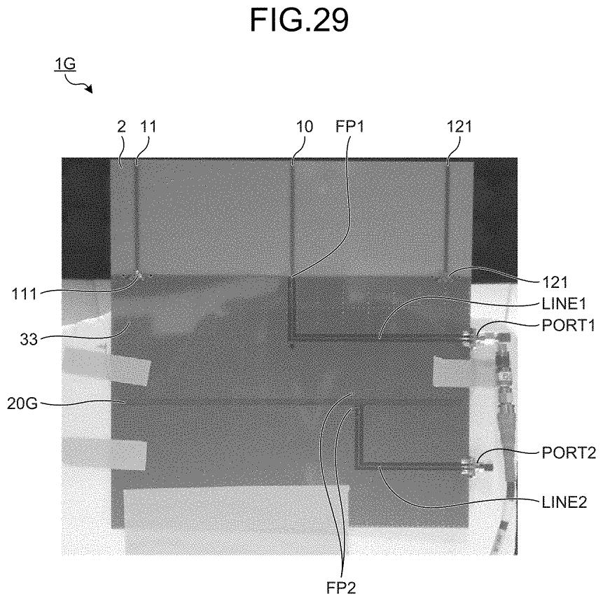

FIG. 29 is a diagram illustrating a prototype. As illustrated in FIG. 29, in the prototype, the antenna 10 is excited from a port PORT1 via a transmission line LINE1 (and a feeding point FP1). The antenna 20G is excited from a port PORT2 via a transmission line LINE2 (feeding point FP2). The transmission line LINE1 and the transmission line LINE2 are microstrip lines in this example. However, a coplanar line, a strip line, or the like may be used in addition to the microstrip line. Description of the substrate 2, the antenna 10, the antenna 20G, and base plate 33 are similar to the simulation conditions described above, and thus duplicated description is not given here.

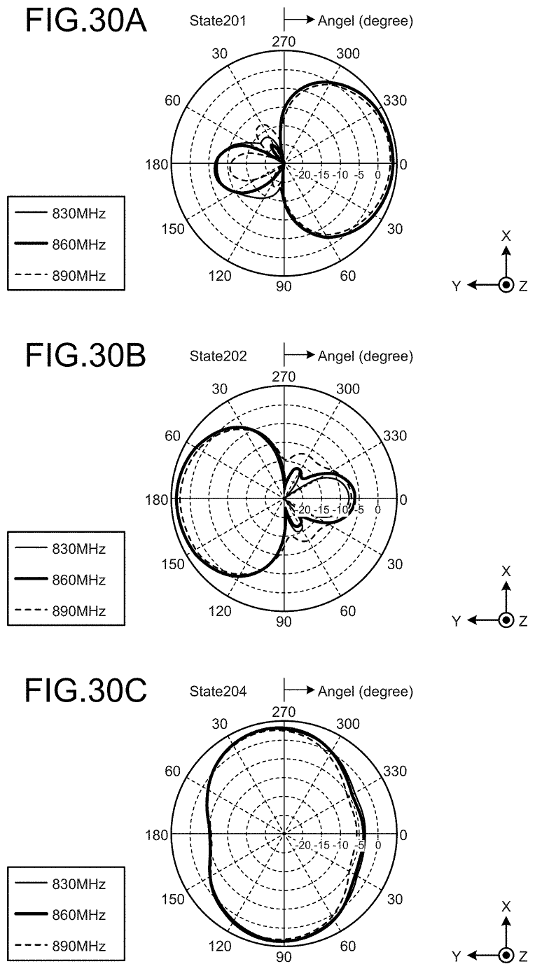

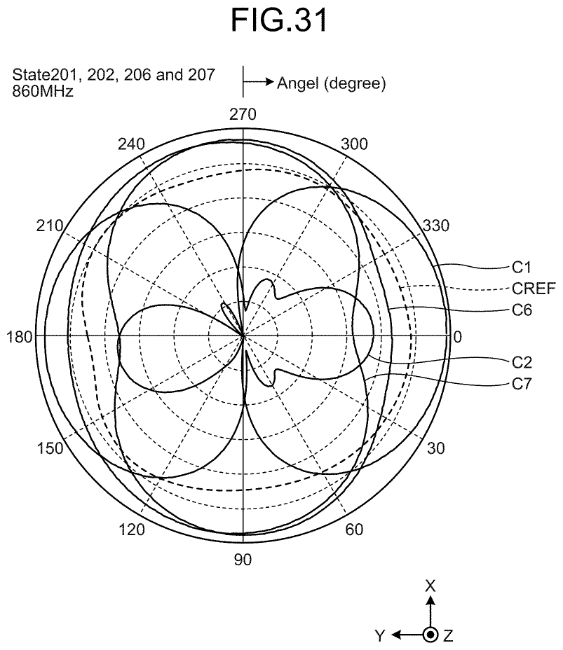

FIGS. 30A to 30C and 31 illustrate experimental results of the prototype illustrated in FIG. 29.

FIG. 30A illustrates an experimental result of State 201. The solid line indicates directivity at a frequency of 830 MHz. The thick solid line indicates directivity at a frequency of 860 MHz. The broken line indicates directivity at a frequency of 890 MHz. It was possible to obtain an experimental result close to the simulation result described above with reference to FIG. 21A and the like.

FIG. 30B illustrates an experimental result of State 202. It was possible to obtain an experimental result close to the simulation result described above with reference to FIG. 22A and the like.

FIG. 30C illustrates an experimental result of State 204. It was possible to obtain an experimental result close to the simulation result described above with reference to FIG. 24A and the like.

FIG. 31 illustrates experimental results of State 201, State 202, State 206, and State 207. A curve C1, a curve C2, a curve C6, and a curve C7 each indicate the directivity of the State 201, the State 202, the State 206, and the State 207, respectively. The curve CREF indicates the directivity of a commercially available sleeve dipole antenna (substantially omnidirectional antenna). When viewed in the XY plane, for example, it has been confirmed that a gain up to 5 dBi is obtained in all directions of 360 degrees by switching between State 201, State 202, State 206, and State 207.

### 2.5 Modification

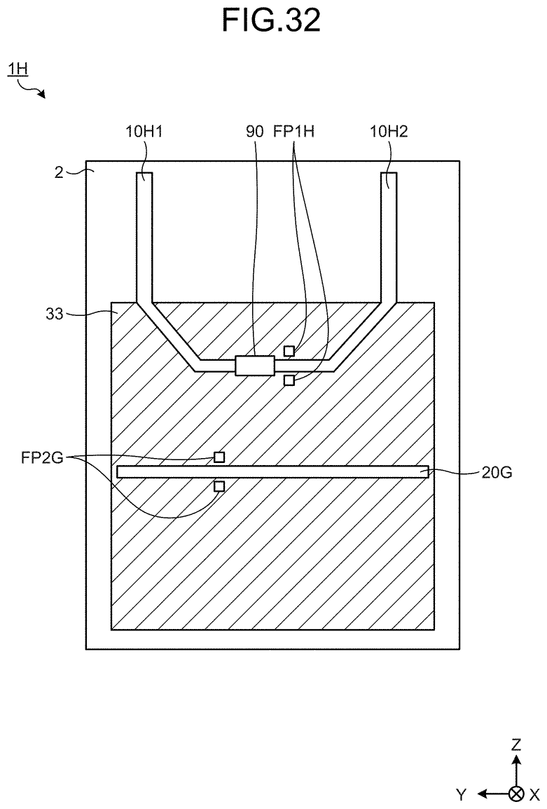

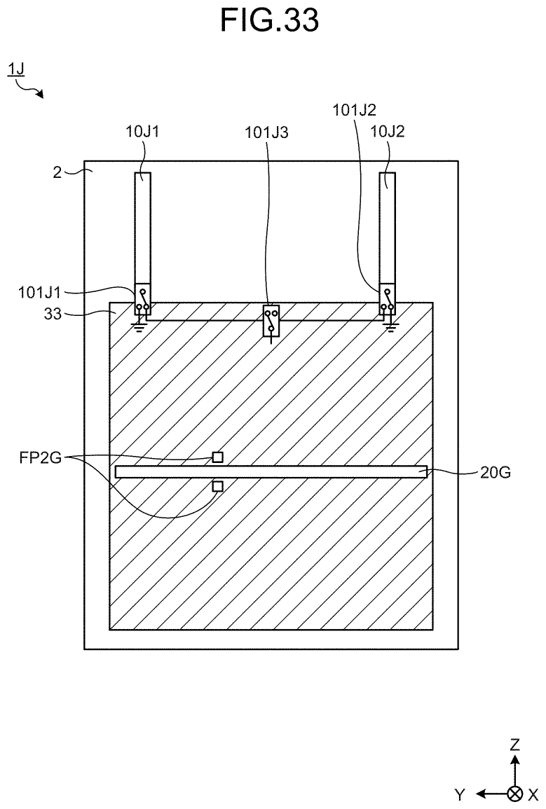

Some modifications of the antenna device 1G will be described with reference to FIGS. 32 and 33.

For example, in one antenna, the directivity may be controlled using a pair of antennas instead of using a parasitic element. FIG. 32 is a plan view illustrating a schematic configuration of an antenna device according to such a modification. An antenna device 1H illustrated in FIG. 32 is different from the antenna device 1G (FIG. 18) in that the antenna device 1H includes an antenna 10H1 and an antenna 10H2 instead of the antenna 10, and further includes a hybrid element 90. Both the antenna 10H1 and the antenna 10H2 are monopole antennas extending in the Z-axis positive direction. The hybrid element 90 is a 90 degree hybrid element and is configured to distribute a signal from the feeding point FP1H so as to enable a signal having a phase different by 90° to be supplied to each of the antenna 10H1 and the antenna 10H2. The antenna 10 may be excited in a first frequency band (for example, 800 MHz band) and the antenna 20 may be excited in a second frequency band (for example, 2 GHz band). The signal in the first frequency band is radiated by the antenna 10 with directivity in the Y-axis direction. The signal in the second frequency band is radiated by the antenna 20 with directivity in the X-axis direction. This enables the antenna device 1H to function as a straight beam antenna by which directivities of different frequency bands constituting the multiband mutually go straight to each other. Furthermore, by using a pair of antennas, it is possible to downsize the antenna device 1H as compared with a configuration including two elements, namely, the parasitic element 11 and the parasitic element 12.

Furthermore, similarly to the example of FIG. 14, the antenna and the parasitic element may be functionally switched between the above-described pair of antennas, for example. FIG. 33 is a plan view illustrating a schematic configuration of an antenna device according to such a modification. An antenna device 1J illustrated in FIG. 33 is different from the antenna device 1H (FIG. 32) in that the antenna device 1J includes an antenna 10J1 and an antenna 10J2 in place of the antenna 10H1 and the antenna 10H2, includes a switch 101J1 and a switch 101J2, and does not include the hybrid element 90.

The switch 101J1 is an SPDT switch connected between the antenna 10J1, the base plate 33, and a switch 101J3. The switch 101J1 switches between a state in which the antenna 10J1 is connected to the base plate 33 and a state in which the antenna 10J1 is connected to the switch 101J3. The switch 101J1 is switched by the switching control block 500 (FIG. 6).

The switch 101J2 is an SPDT switch connected between the antenna 10J2, the base plate 33, and the switch 101J3. The switch 101J2 switches between a state in which the antenna 10J2 is connected to the base plate 33 and a state in which the antenna 10J2 is connected to the switch 101J3. The switch 101J2 is switched by the switching control block 500 (FIG. 6).

The switch 101J3 is an SPDT switch connected between the switch 101J2, the switch 101J2, and the signal source 40 (refer to FIG. 4A and the like). The switch 101J3 switches between a state in which the switch 101J1 is connected to the signal source 40 (excited state) and a state in which the switch 101J2 is connected to the signal source 40 (excited state).

By switching the switch 101J1, the switch 101J2, and the switch 101J3, the use of the antenna 10J1 and the antenna 10J2 can be switched between the antenna and the parasitic element. By using a pair of antennas, it is possible to downsize the antenna device 1J as compared with a configuration including two elements, namely, the parasitic element 11 and the parasitic element 12.

It is also possible to use a modification of the antenna device 1G according to the second embodiment, similarly to the antenna device 1 according to the first embodiment. For example, the parasitic element 21 and the parasitic element 22 for the antenna 20 as described above with reference to FIG. 2 may be provided for the antenna 20G of the antenna device 1G. These parasitic elements may be provided so as to extend along the extending direction (Y-axis direction) of the antenna 20G. Furthermore, the modification described above with reference to FIGS. 11 to 17 may also be applied to a substrate 2G.

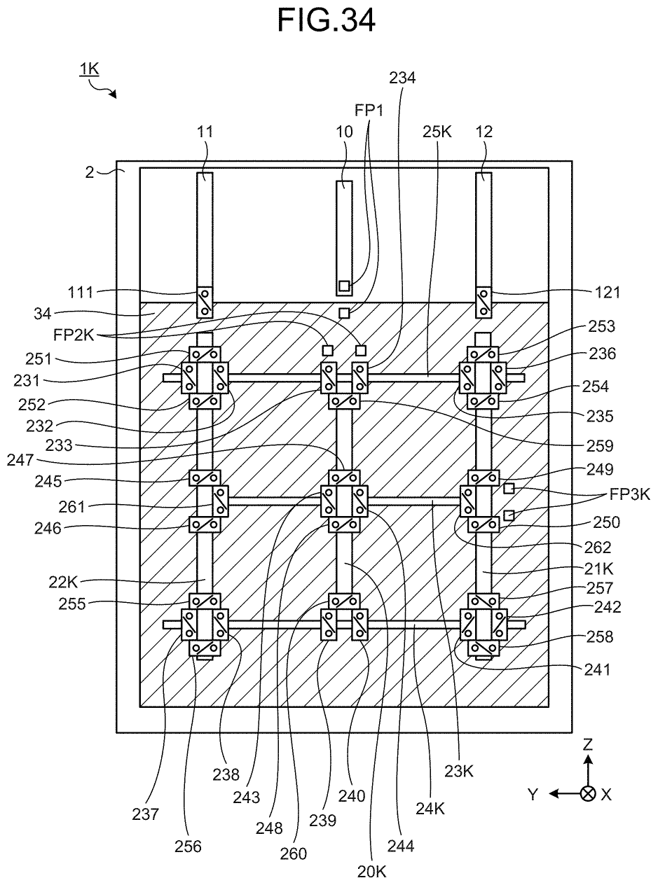

For example, a slot antenna extending in the Z-axis direction like the antenna 20 and a slot antenna extending in the Y-axis direction like the antenna 20 G may coexist. FIG. 34 is a plan view illustrating a schematic configuration example of an antenna device according to such a modification. An antenna device 1K illustrated in FIG. 34 includes an antenna 20K, a parasitic element 21K, a parasitic element 22K, an antenna 23K, a parasitic element 24K, and a parasitic element 25K, as slot lines formed by a base plate 34.

The antenna 20K is a slot antenna extending in the Z-axis direction, and is excited via the feeding point FP2. The parasitic element 21K and the parasitic element 22K are provided on either side of antenna 20K. The antenna 23K is a slot antenna extending in the Y-axis direction, and is excited via a feeding point FP3K. The parasitic element 24K and the parasitic element 25K are provided on either side of the antenna 23K. The feeding point FP2K is disposed at a certain position along the antenna 20K, and the feeding point FP3K is disposed at a certain position along the antenna 23K. Note that it is desirable to avoid the inside of the parasitic slot.

The antenna device 1K includes switches 251 to 262 as a switch for switching the lengths of the antenna 20K, the parasitic element 21K, the parasitic element 22K, the antenna 23K, the parasitic element 24K, and the parasitic element 25K. In the example illustrated in FIG. 34, the switches 251 to 262 are provided so as to surround the intersection of the slot lines. The arrangement of the switches is not limited to the example of FIG. 34.

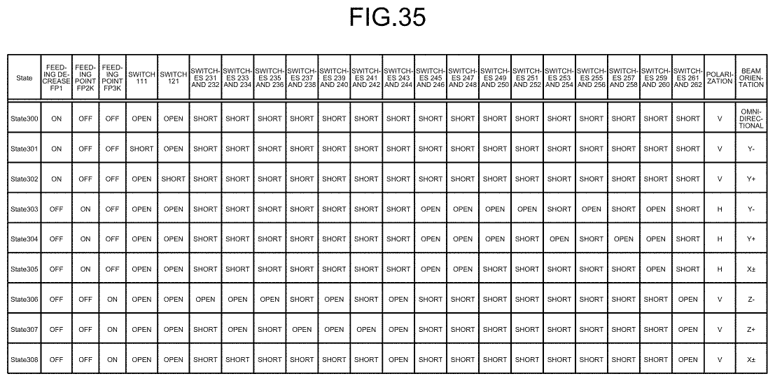

The antenna device 1K also has various States as described below by the switching control block 500 (FIG. 6). FIG. 35 is a diagram illustrating an example of States. “V” indicates a vertically polarized wave, and “H” indicates a horizontally polarized wave. As illustrated in FIG. 35, obtained States are State 300 to State 308 in which the polarization and the directivity are switched. It is possible to various States by individually switching the respective feeding points and switches, not limited to the example illustrated in FIG. 35.

The above embodiment is an example in which the components of the antenna device 1 such as the antenna, the parasitic element, the base plate, and the switch group are provided on the front surface of the substrate 2. Alternatively, some or all of the components of the antenna device 1 may be provided on the back surface of the substrate 2.

The frequency band of the antenna device according to the embodiment is not limited to the 800 MHz and 2 GHz bands, regarding which a person skilled in the art can understand from the scope of the above description. Examples of other frequency bands include a 2.4 GHz band, a 5 GHz band, and a millimeter wave band which is a higher frequency band. The antenna device according to the embodiment may be applied to radio waves in any frequency band including these. The antenna device may be applied to any radio system that utilizes those frequency bands. Examples of the radio system include Long Term Evolution (LTE), Ultra Wide Band (UWB), and WiFi (registered trademark). The antenna device can be applied to any application using those frequency bands or radio systems. Examples of the application include phone calls, data communication, ranging, positioning, and motion sensing.

### 3. Further Examples of Control System

The above embodiment has described, with reference to FIG. 6, the control system that generates the switching signal for controlling each switch and the like based on the indexes such as the reception level information (referred to as RSSI), the transmission level information, the reception QoS information (SIR, BER), and the transmission QoS information. More specifically about the index, the transmission level information may include transmission power and the like. The reception QoS information may include an indicator included in the packet in addition to the SIR and the BER. The similar applies to the transmission QoS information. These indexes are transmitted from the modulation/demodulation signal processing block 600 to the switching control block 500, for example.

The indicator included in the packet will be described. Not a few radio transmission/reception signals include, in its packet, an indicator indicating quality of a signal. An example of the indicator is a numerical value defined corresponding to the level of quality. Examples of the numerical value include Numerical value 1 indicating good quality, Numerical value 2 indicating low quality, Numerical value 3 indicating low reliability (Unreliable for any reason like Signal Lost, etc.), and Numerical value 4 indicating unknown quality.

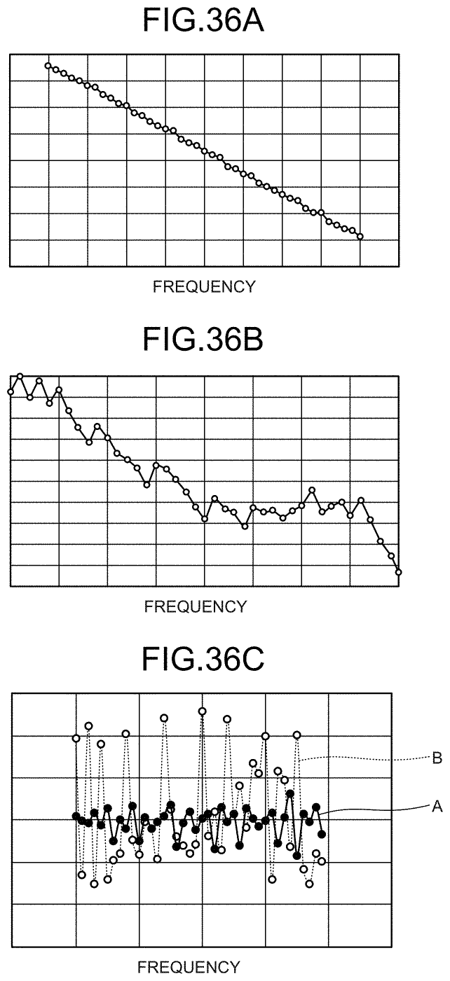

Still another example of the index is information related to a frequency characteristic. The information regarding the frequency characteristic includes information regarding the frequency characteristic of the reception signal and the frequency characteristic of the transmission signal. Examples of the information regarding the frequency characteristic of the reception signal include a frequency characteristic of a phase or an amplitude of the reception signal and information based on the frequency characteristic (slope value, moving average value, etc.). Examples of the information regarding the frequency characteristic of the transmission signal include a frequency characteristic of a phase or an amplitude of the transmission signal and information based on the frequency characteristic (slope value, moving average value, etc.). The phase or the amplitude may be a relative value when the phase or the amplitude at a certain frequency is used as a reference. Indexes like these will be described with reference to FIGS. 36A to 36C.

FIGS. 36A to 36C are diagrams each schematically illustrating an example of information regarding frequency characteristics. Among these drawings, FIGS. 36A and 36B illustrate examples of frequency characteristics of phases or amplitudes in different States. The horizontal axis of the graph represents frequency, and the vertical axis represents phase or amplitude. The frequency range is a transmission/reception frequency band (for example, 2.4 GHz to 2.48 GHz) of the antenna. In a certain State, as illustrated in FIG. 36A, with an increase in the frequency, the phase or amplitude changes so as to decrease at a substantially constant rate. In another State, as illustrated in FIG. 36B, with an increase in the frequency, the phase or amplitude changes irregularly with repetitions of increases and decreases. In this manner, since the frequency characteristic varies depending on the State, the frequency characteristic of the phase or amplitude of the transmission signal or the reception signal can be used as an index. For example, it is allowable to perform control so as to select a State in which the frequency characteristic satisfies a predetermined condition, select a State that optimizes the frequency characteristic, or select a State that minimizes the variation in the frequency characteristic.

FIG. 36C illustrates an example of slope values of frequency characteristics of phases or amplitudes in different States. Graph line A indicates a slope value of the frequency characteristic illustrated in FIG. 36A described above. Graph line B indicates the slope of the frequency characteristic illustrated in FIG. 36C described above. Since the slope of the frequency characteristic of the phase or the amplitude varies depending on the State, the slope of the frequency characteristic of the phase or the amplitude can also be used as an index. For example, it is allowable to perform control so as to select a State in which the variation in the slope value of the frequency characteristic satisfies a predetermined condition (using an initial value of −30 dB/Hz or less, for example), or select a State that minimizes the variation in the slope value of the frequency characteristic.

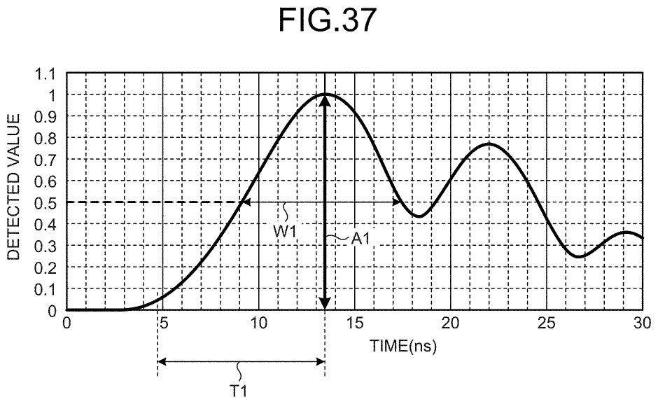

Still another example of the index is information related to the time-axis waveform. The information regarding the time-axis waveform includes information regarding the time-axis waveform of the reception signal and information regarding the time-axis waveform of the transmission signal. Examples of the information regarding the time-axis waveform of the reception signal include the time-axis waveform of the reception signal and information (width of initial peak, amplitude of initial peak, detection time of initial peak, and the like) based on the time-axis waveform. Examples of the information regarding the time-axis waveform of the transmission signal include the time-axis waveform of the transmission signal and information (width of initial peak, amplitude of initial peak, detection time of initial peak, and the like) based on the time-axis waveform. The information regarding the time-axis waveform is useful, for example, when the antenna device 1 is used as a ranging/positioning device or the like. Information regarding the time-axis waveform will be described with reference to FIG. 37.

FIG. 37 is a diagram schematically illustrating an example of information regarding the time-axis waveform. The horizontal axis of the graph represents time, and the vertical axis represents an amplitude value (detection value). The amplitude value is normalized by the value of the first wave peak. The time from the detection of the signal to the first wave peak is referred to as time T1. The first wave peak is referred to as a width W1 in the drawing. The time T1 starts when the amplitude value of the detection signal first exceeds a predetermined level (in this example, about 0.05). Note that, in this example, the detection amplitude reaches 0.5 when half of the time T1 has elapsed from the start of detection.

Since the radiation pattern of the antenna is switched depending on the State as described above, the time-axis waveform as illustrated in FIG. 37 can also differ depending on the State. Therefore, the time-axis waveform can also be used as an index. For example, it is allowable to perform control so as to select a State in which the time-axis waveform (Time T1, width W1, etc.) satisfies a predetermined condition. In the case of using the time T1, an initial value of the predetermined condition may be set to 15 ns or less, 10 ns or less, for example, and a State satisfying the initial value may be selected. It is allowable to perform control so as to select a State that optimizes the time-axis waveform (Time T1, width W1, etc.). For example, a State in which the time T1 is the shortest may be selected. Alternatively, a State in which the width W1 is the narrowest may be selected.

The confirmation of the index in the ranging/positioning described above can be performed in each State. At that time, in a case where a predetermined condition is satisfied in a plurality of States, it is allowable to perform post-processing such as adopting an average, adopting a best value, or determining with reference to another index.

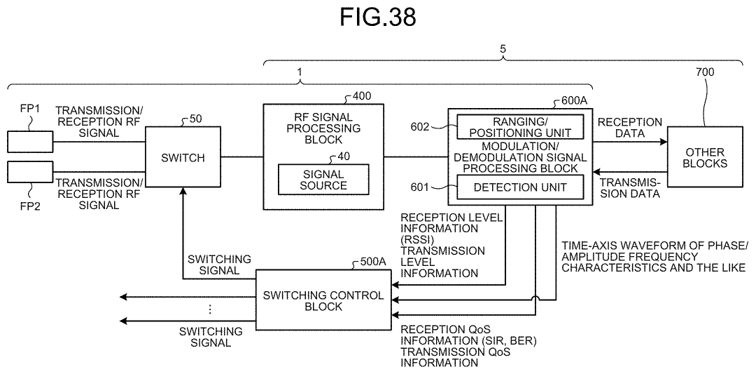

A control system that generates a switching signal for controlling each switch and the like based on an index including the above-described frequency characteristics and the like and a time-axis waveform and the like will be described with reference to FIG. 38. FIG. 38 is a diagram illustrating an example of a schematic configuration of an antenna device and an electronic device on which the antenna device is mounted. Hereinafter, differences from FIG. 6 will be specifically described.

A modulation/demodulation signal processing block 600A includes a detection unit 601 and a ranging/positioning unit 602. The detection unit 601 detects information regarding the frequency characteristics and the information regarding the time-axis waveform described above, thereby acquiring their indexes. The detection unit 601 includes, for example, a signal extractor and an error counter. The acquired index is transmitted from the modulation/demodulation signal processing block 600A to a switching control block 500A. The switching control block 500A generates a switching signal for controlling each switch based on the index transmitted from the modulation/demodulation signal processing block 600. The operation of switching the antenna device 1 to the State in which the desired directivity is obtained has been described above.

The ranging/positioning unit 602 performs ranging and/or positioning (hereinafter, referred to as “ranging/positioning” in some cases). Ranging and positioning are performed, for example, by using at least one of the antenna 10 or the antenna 20 (FIG. 1) as a ranging/positioning antenna. Since the principle of ranging/positioning is known, description will be simplified. Each of the antenna 10 and the antenna 20 may be used as a separate ranging/positioning antenna. In this case, two ranging/positioning results are obtained, namely, a ranging/positioning result obtained by the antenna 10 and a ranging/positioning result obtained by the antenna 20.

The following description is an example of using two ranging/positioning results, that is, a ranging/positioning result obtained by the antenna 10 and a ranging/positioning result obtained by the antenna 20. It is also allowable to use an index for the antenna 10 and an index for the antenna 20, and in that case, the two ranging/positioning results may be adopted according to the confirmation result of the index. In an example of ranging, the confirmation result may be a comparison result of the indexes of the two antennas (for example, a difference between the indexes). A priority may be given to the index, and in this case, comparison may be performed sequentially from an index having a higher priority, and the confirmation processing may be completed at a time point when a difference of a certain level or more is confirmed. As an example, when the indicator, among the two indexes, namely, the indicator and the width W1, has higher priority, it is allowable to use the distance obtained by the ranging by the antenna having the better numerical value (quality) of the indicator. When the numerical values of the indicators are the same (with no difference), it is allowable to confirm whether the width W1 is within a certain range, and use the distance obtained by the ranging by the antenna of the index satisfying the condition. When there is no significant difference between the indicator and the width W1, for example, it is allowable to use the shorter distance obtained by ranging out of the distances obtained by ranging by two antennas.

When the difference between the distance measurement results of the two antennas is equal to or less than a predetermined value (for example, a distance corresponding to 1.5 ns), the average value of the two distances obtained by ranging may be used without performing the prioritized index confirmation as described above. Execution of averaging leads to accuracy improvement. When the difference is larger than the predetermined value, it is also allowable to select the distance obtained by ranging to be used, based on reliability information calculated from an index such as an indicator.

The confirmation of the index in the ranging/positioning described above can be performed in each State. At that time, in a case where a predetermined condition is satisfied in a plurality of States, it is allowable to perform post-processing such as adopting an average, adopting a best value, or determining with reference to another index.

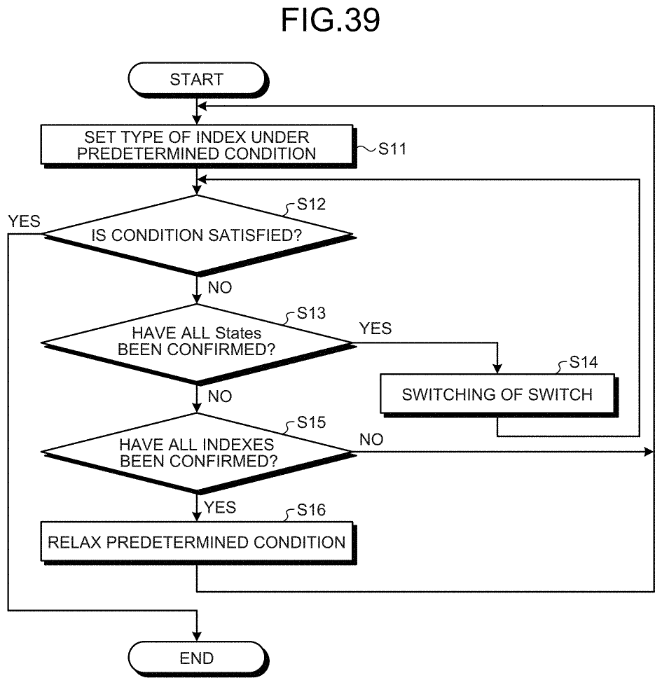

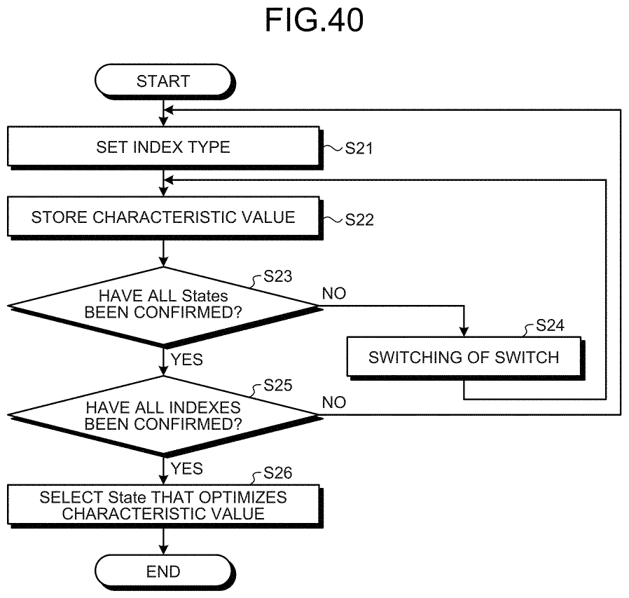

In view of the above, various types of switching control processing may be performed in addition to the switching control processing (the method for controlling the antenna device) described above with reference to FIG. 11. Some examples will be described with reference to FIGS. 39 and 40.

For example, when there is no found State in which the index satisfies the predetermined condition in the processing of searching for the State in which the index satisfies the predetermined condition, the predetermined condition may be relaxed. This will be described with reference to FIG. 39.

FIG. 39 is a flowchart illustrating an example of the switching control processing (the method for controlling the antenna device). This processing is repeatedly executed by the switching control block 500A while transmission and reception (use of the electronic device 5) by the antenna device 1 is performed, for example.

In Step S11, the type of the index is set under a predetermined condition. For example, the time T1 to the first wave peak of 10 ns or less as described above is set as the predetermined condition and the index type. A predetermined condition is also set for other indexes.

In Step S12, it is determined whether the condition is satisfied. Specifically, it is determined whether the acquired index satisfies the predetermined condition set in the previous Step S11. When the condition is satisfied (Step S12: Yes), the processing of the flowchart ends. Otherwise (Step S12: No), the processing proceeds to Step S13.

In Step S13, it is determined whether all the States have been confirmed. Specifically, when all the States have become symmetric in the processing of Step S12 so far, it is determined that all the States have been confirmed. When all the States have been confirmed (Step S13: Yes), the processing proceeds to Step S14. Otherwise (Step S13: No), the processing proceeds to Step S15.

In Step S14, the switch is switched, and the processing returns to Step S12. The switching of the switch here is switching to a State in which the processing of Step S12 has not been symmetric so far.

In Step S15, it is determined whether all the indexes have been confirmed. Specifically, when all the indexes have been symmetric in the processing of Step S12 so far, it is determined that all the indexes have been confirmed. When all the indexes have been confirmed (Step S15: Yes), the processing proceeds to Step S16. Otherwise (Step S15: No), the processing returns to Step S11. In Step S11, the type of the index that is not symmetric in the processing of Step S12 is set.

In Step S16, the predetermined condition is relaxed, and the processing returns to Step S11. For example, the above 10 nm or less is relaxed to 15 nm or less. The predetermined condition is relaxed for other indexes.

According to the above processing, when there is no found State satisfying an initial predetermined condition (initial condition), the predetermined condition is relaxed. Therefore, the antenna device 1 can be reliably switched to a State capable of obtaining a desired directivity or a (suboptimal) directivity close to the desired directivity.

Alternatively, an optimum State may be selected after confirming all indexes in all States (combinations of all States and indexes). This will be described with reference to FIG. 40. FIG. 40 is a flowchart illustrating an example of the switching control processing (the method for controlling the antenna device).

In Step S21, the type of the index is set. For example, the time T1 to the first wave peak is set.

In Step S22, the characteristic value is stored. Specifically, the index set in Step S21 is acquired, and the acquisition result is stored in a storage unit (not illustrated) accessible by the switching control block 500. In the case of the ranging/positioning device, a ranging/positioning result or the like by each antenna may also be stored.

In Step S23, it is determined whether all the States have been confirmed. Specifically, when all the States have been symmetric in the processing of Step S22 so far, it is determined that all the States have been confirmed. When all the States have been confirmed (Step S23: Yes), the processing proceeds to Step S25. Otherwise (Step S23: No), the processing proceeds to Step S24.

In Step S24, the switch is switched, and the processing returns to Step S22. The switching of the switch here is switching to a State in which the processing of Step S22 has not been symmetric so far.

In Step S25, it is determined whether all the indexes have been confirmed. Specifically, when all the indexes have been symmetric in the processing of Step S22 so far, it is determined that all the indexes have been confirmed. When all the indexes have been confirmed (Step S25: Yes), the processing proceeds to Step S26. Otherwise (Step S25: No), the processing returns to Step S21.

Step S26 selects a State that optimizes the characteristic value. Specifically, the antenna device 1 is switched to the State corresponding to the optimum characteristic value among the characteristic values stored in the previous Step S22.

With the above processing, the antenna device 1 can be switched to the optimum State based on the confirmation results of all the States and indexes. In the case of the ranging/positioning device, two ranging/positioning results may be adopted according to the confirmation result of each index in the State switched in this manner, as described above.

### 4. Effects

The antenna device described above is specified as follows, for example. As illustrated in FIGS. 1 and 2 and the like, the antenna device 1 includes the antenna 10, the antenna 20, the parasitic element 11, the parasitic element 12, the parasitic element 21, the parasitic element 22, the base plate 30, and the switch group. The antenna 10 radiates the first polarized wave. The antenna 20 radiates the second polarized wave. The switch group includes a switch 111, a switch 121, a switch 211, a switch 212, a switch 221, and a switch 222 connected to the parasitic element 11, the parasitic element 12, the parasitic element 21, and the parasitic element 22, and includes the switches 301 to 308 connected to the base plate 30 (hereinafter, the switches may be simply referred to as the “switch 111 and the like”).

According to the antenna device 1 described above, by switching the parasitic element 11, the parasitic element 12, the parasitic element 21, the parasitic element 22, and the switch 111 and the like connected to the base plate 30, it is possible to change the directivity of the antenna 10 that radiates the first polarized wave and the antenna 20 that radiates the second polarized wave. By changing the directivities of the two antennas 10 and 20 in various ways according to the switching combination of the switch 111 and the like in this manner, the radiation pattern (directivity and polarization) can be flexibly controlled. Therefore, the radiation pattern can be controlled with a high degree of freedom.

As illustrated in FIG. 2 and the like, the parasitic element 11 and the parasitic element 12 may face the antenna 10. For example, the directivity of the antenna 10 can be controlled by the parasitic element 11 and the parasitic element 12 disposed in this manner.

As illustrated in FIG. 2 and the like, the antenna 10 may be a monopole antenna formed of a conductive member. Parasitic element 11 and the parasitic element 12 may be formed of a conductive member. Switch 111 and switch 121 may be connected between parasitic element 11 and the parasitic element 12, and base plate 30. With this configuration, the directivity of the monopole antenna can be controlled according to the connection state between parasitic elements 11 and 12 and base plate 30.

As illustrated in FIG. 2 and the like, the parasitic element 11 and the parasitic element 12 may be a pair of parasitic elements located on either side of the antenna 10. For example, by arranging the antenna 10, the parasitic element 11, and the parasitic element 12 side by side in one direction (Y-axis direction) in this manner, it is possible to control the directivity of the antenna 10.

As illustrated in FIG. 14 and the like, the antenna device 1C may further include the feeding point FP1C0 provided in the antenna 10C, and the feeding point FP1C1 and the feeding point FP1C2 provided in the parasitic element 11C and the parasitic element 12C. With the switch 101 set to SHORT, the antenna 10C can be used as a parasitic element instead of exciting the antenna 10C via the feeding point FP1C0. With the switch 111 and/or the switch 121 set to OPEN, the parasitic element 11C and/or the parasitic element 12C can be excited via the feeding point FP1C1 and/or the feeding point FP1C2, and can be used as an antenna.

As illustrated in FIG. 16 and the like, the antenna device 1E may include the variable reactance element 111E and the variable reactance element 121E connected between the parasitic element 11 and the base plate 30. Different directivities can be obtained also by changing the reactance values of the variable reactance element 111E and the variable reactance element 121E to switch the connection state between the parasitic element 11 and the base plate 30.

As illustrated in FIG. 15 and the like, the antenna 10D may have a bent portion (or a curved portion). Different directivities can be obtained according to the bent shape (or curved shape) of the antenna 10D. This also leads to downsizing of the antenna device 1D.

As illustrated in FIG. 32 and the like, the antenna 10H1 and the antenna 10H2 may be a pair of antennas. The antenna device 1H may further include the hybrid element 90 provided between the antenna 10H1 and the antenna 10H2. Using the pair of antennas makes it possible to achieve downsizing of the antenna device 1H.

As illustrated in FIG. 2 and the like, the parasitic element 21 and the parasitic element 22 may face the antenna 20. For example, the directivity of the antenna 20 can be controlled by the parasitic element 21 and the parasitic element 22 disposed in this manner.

As illustrated in FIG. 2 and the like, the antenna 20 may be a slot antenna formed by the base plate 30. The parasitic element 21 and the parasitic element 22 may each be a slot line formed by base plate 30. The switch 211, the switch 212, the switch 221, and the switch 222 may be connected between the base plates 30 on both sides of the parasitic element 21 and the parasitic element 22. In addition, as illustrated in FIG. 17 and the like, the switch group may include the switch 213F and the switch 223F connected between the base plates 30 on both sides of the parasitic element 21F and the parasitic element 22F. With this configuration, the directivity of the slot antenna can be controlled according to the connection state between parasitic elements 21 and 22 and base plate 30.

As illustrated in FIG. 2 and the like, the parasitic element 21 and the parasitic element 22 may be a pair of parasitic elements located on either side of the antenna 20. For example, by arranging the antenna 20, the parasitic element 21, and the parasitic element 22 side by side in one direction (Y-axis direction) in this manner, it is possible to control the directivity of the antenna 20.

As illustrated in FIG. 14 and the like, the antenna device 1C may further include the feeding point FP2C0 provided in the antenna 20C, and the feeding point FP2C1 and the feeding point FP2C2 provided in the parasitic element 21C and the parasitic element 22C. The switch group may include the switch 201C connected in parallel to the feeding point FP2C0, the switch 212C connected in parallel to the feeding point FP2C1, and the switch 222C connected in parallel to the feeding point FP2C2. With the switch 201C set to SHORT, the antenna 20C can be used as a parasitic element instead of exciting the antenna 20C via the feeding point FP2C0. With the switch 212C and/or the switch 222C set to OPEN, the parasitic element 21C and/or the parasitic element 22C can be excited via the feeding point FP2C1 and/or the feeding point FP2C2, and can be used as an antenna.

As illustrated in FIGS. 2, 13, and the like, the base plate 30 may include the divided base plate 31 and the divided base plate 32. The switches 301 to 308 may be connected between the divided base plate 31 and the divided base plate 32. Furthermore, the divided base plate 32 may include a plurality of divided base plates of the first portion 321 to fifth portion 325. The switch group may include switches 309 to 316 connected between the first portion 321 to the fifth portion 325. With this configuration, the directivity can be controlled by changing the pattern of base plate 30 in various ways.

As illustrated in FIGS. 2, 34, and the like, the antenna 20 may include the antenna 20K extending in the same direction as the antenna 10. Alternatively, as illustrated in FIGS. 18, 34, and the like, the antenna 20G may include the antenna 23K extending in a direction intersecting (for example, a direction orthogonal to) the extending direction of the antenna 10. By changing the extending direction of the second antenna in this manner, it is possible to change the polarization direction and control the directivity.

As illustrated in FIG. 6 and the like, the antenna device 1 may further include the switching control block 500. The switching control block 500 may switch each switch of the switch group based on an index related to transmission and reception. This makes it possible to control the directivity according to the index related to transmission and reception.

As illustrated in FIGS. 6, 38, and the like, the index may include at least one of reception level information, transmission level information, reception QoS information, and transmission QoS information, information regarding the phase of the reception signal and the frequency characteristic of the amplitude, information regarding the phase of the transmission signal and the frequency characteristic of the amplitude, information regarding the time-axis waveform of the reception signal, or information regarding the time-axis waveform of the transmission signal. The directivity can be controlled according to such an index, for example.

As illustrated in FIG. 38 and the like, the antenna device 1 may further include the ranging/positioning unit 602. The ranging/positioning unit 602 may perform ranging or positioning using at least one of the antenna 10 or the antenna 20. This makes it possible to use the antenna device 1 as a positioning/ranging device.

The ranging/positioning unit 602 may perform ranging or positioning based on an index regarding the antenna 10, an index regarding the antenna 20, a ranging/positioning result obtained by the antenna 10, and a ranging/positioning result obtained by the antenna 20. This makes it possible to perform appropriate ranging or positioning based on the index of each antenna and the ranging/positioning result.

As illustrated in FIGS. 1 and 2, the antenna 10, the antenna 20, the parasitic element 11, the parasitic element 12, the parasitic element 21, the parasitic element 22, and the base plate 30 may be provided on the substrate 2. This makes it possible to obtain the downsized antenna device 1 having a planar shape.

For example, the electronic device 5 illustrated in FIG. 6 and the like is also an embodiment of the present disclosure. Since the antenna device 1 is mounted on the electronic device 5, the radiation pattern can be controlled with a high degree of freedom as described above.

For example, a control method illustrated in FIG. 11 and the like is also an embodiment of the present disclosure. This control method is a method of controlling the antenna device 1, and includes acquiring an index related to transmission and reception of at least one of the antenna 10 or the antenna 20 (Step S1), and switching each switch of the switch group based on the index acquired in the Steps of acquiring (Steps S2 and S3). This makes it possible to control the directivity according to the index related to transmission and reception.

Note that the effects described in the present disclosure are merely examples and are not limited to the disclosed contents. There may be other effects.

The embodiments of the present disclosure have been described above. However, the technical scope of the present disclosure is not limited to the above-described embodiments, and various modifications can be made without departing from the scope of the present disclosure. Moreover, it is allowable to combine the components across different embodiments and modifications as appropriate.

The effects described in individual embodiments of the present specification are merely examples, and thus, there may be other effects, not limited to the exemplified effects.

Note that the present technique can also have the following configurations.

(1)

An antenna device comprising:

a first antenna that radiates a first polarized wave;

a second antenna that radiates a second polarized wave;

a parasitic element;

a base plate; and

a switch group including a switch connected to the parasitic element and a switch connected to the base plate.

(2)

The antenna device according to (1),

wherein the parasitic element includes a first parasitic element facing the first antenna.

(3)

The antenna device according to (2),

wherein the first antenna is a monopole antenna formed of a conductive member,

the first parasitic element is formed of a conductive member, and

the switch group includes a switch connected between the first parasitic element and the base plate.

(4)

The antenna device according to (2) or (3),

wherein the first parasitic element includes a pair of first parasitic elements each located on either side of the first antenna.

(5)

The antenna device according to any one of (2) to (4), further comprising:

a first feeding point provided on the first antenna; and

a first additional feeding point provided on the first parasitic element,

wherein the switch group includes a switch connected in parallel to the first feeding point and a switch connected in parallel to the first additional feeding point.

(6)

The antenna device according to (3) or (4),

wherein the switch group includes a variable reactance element connected between the first parasitic element and the base plate.

(7)

The antenna device according to any one of (1) to (4),

wherein the first antenna has at least one of a bent portion or a curved portion.

(8)

The antenna device according to any one of (1) to (5),

wherein the first antenna is provided as a pair of antennas, and

the antenna device further comprises a 90° hybrid element provided between the pair of antennas as the first antenna.

(9)

The antenna device according to any one of (1) to (8),

wherein the parasitic element includes a second parasitic element facing the second antenna.

(10)

The antenna device according to (9),

wherein the second antenna is a slot antenna formed by the base plate,

the second parasitic element is a slot line formed by the base plate, and

the switch group includes a switch connected between base plates on both sides on the second parasitic element.

(11)

The antenna device according to (9) or (10),

wherein the second parasitic element includes a pair of second parasitic elements each located on either side of the second antenna.

(12)

The antenna device according to any one of (9) to (11), further comprising:

a second feeding point provided on the second antenna; and

a second additional feeding point provided on the second parasitic element,

wherein the switch group includes a switch connected in parallel to the second feeding point and a switch connected in parallel to the second additional feeding point.

(13)

The antenna device according to any one of (1) to (12),

wherein the base plate includes a plurality of divided base plates, and

the switch group includes a switch connected between the plurality of divided base plates.

(14)

The antenna device according to any one of (1) to (13),

wherein the second antenna includes an antenna extending in a same direction as the first antenna.

(15)

The antenna device according to any one of (1) to (14),

wherein the second antenna includes an antenna extending in a direction intersecting an extending direction of the first antenna.

(16)

The antenna device according to any one of (1) to (15), further comprising

a switching unit configured to switch each switch of the switch group,

wherein the switching unit switches each switch of the switch group based on an index related to transmission and reception.

(17)

The antenna device according to (16),

wherein the index includes at least one of reception level information, transmission level information, reception Quality of Service (QoS) information, and transmission QoS information, information regarding the phase of the reception signal and the frequency characteristic of the amplitude, information regarding the phase of the transmission signal and the frequency characteristic of the amplitude, information regarding the time-axis waveform of the reception signal, or information regarding the time-axis waveform of the transmission signal.

(18)

The antenna device according to any one of (1) to (17), further comprising

a ranging/positioning unit that performs either ranging or positioning using at least one of the first antenna or the second antenna.

(19)

The antenna device according to (17), further comprising

a ranging/positioning unit that performs either ranging or positioning by using the index for the first antenna and the index for the second antenna, and using a ranging/positioning result obtained by the first antenna and a ranging/positioning result obtained by the second antenna.

(20)

The antenna device according to any one of (1) to (19),

wherein the first antenna, the second antenna, the parasitic element, and the base plate are provided on a substrate.

(21)

An electronic device on which an antenna device is mounted,

the antenna device including:

a first antenna that radiates a first polarized wave;

a second antenna that radiates a second polarized wave;

a parasitic element;

a base plate; and

a switch group including at least a switch connected to the parasitic element and a switch connected to the base plate.

(22)

A method of controlling an antenna device,

the antenna device including:

a first antenna that radiates a first polarized wave;

a second antenna that radiates a second polarized wave;

a parasitic element;

a base plate; and

a switch group including at least a switch connected to the parasitic element and a switch connected to the base plate,

the control method including steps of:

acquiring an index related to transmission and reception of at least one of the first antenna or the second antenna; and

switching each switch of the switch group based on the index acquired in the step of acquiring.

### REFERENCE SIGNS LIST

1 ANTENNA DEVICE

2 SUBSTRATE

5 ELECTRONIC DEVICE

10 ANTENNA

20 ANTENNA

30 BASE PLATE

31 FIRST BASE PLATE

32 SECOND BASE PLATE

40 SIGNAL SOURCE

50 SWITCH

111 SWITCH

121 SWITCH

211 SWITCH

212 SWITCH

221 SWITCH

222 SWITCH

301 SWITCH

302 SWITCH

303 SWITCH

304 SWITCH

305 SWITCH

306 SWITCH

307 SWITCH

308 SWITCH

400 RF SIGNAL PROCESSING BLOCK

500 SWITCHING CONTROL BLOCK

600 MODULATION/DEMODULATION SIGNAL PROCESSING BLOCK

601 DETECTION UNIT

602 RANGING/POSITIONING UNIT

700 OTHER BLOCKS

1. An antenna device comprising:
a first antenna that radiates a first polarized wave;
a second antenna that radiates a second polarized wave;
a parasitic element;
a base plate; and
a switch group including a switch connected to the parasitic element and a switch connected to the base plate.

2. The antenna device according to claim 1,
wherein the parasitic element includes a first parasitic element facing the first antenna.

3. The antenna device according to claim 2,
wherein the first antenna is a monopole antenna formed of a conductive member,
the first parasitic element is formed of a conductive member, and
the switch group includes a switch connected between the first parasitic element and the base plate.

4. The antenna device according to claim 2,
wherein the first parasitic element includes a pair of first parasitic elements each located on either side of the first antenna.

5. The antenna device according to claim 2, further comprising:
a first feeding point provided on the first antenna; and
a first additional feeding point provided on the first parasitic element,
wherein the switch group includes a switch connected in parallel to the first feeding point and a switch connected in parallel to the first additional feeding point.

6. The antenna device according to claim 3,
wherein the switch group includes a variable reactance element connected between the first parasitic element and the base plate.

7. The antenna device according to claim 1,
wherein the first antenna has at least one of a bent portion or a curved portion.

8. The antenna device according to claim 1,
wherein the first antenna is provided as a pair of antennas, and
the antenna device further comprises a 90° hybrid element provided between the pair of antennas as the first antenna.

9. The antenna device according to claim 1,
wherein the parasitic element includes a second parasitic element facing the second antenna.

10. The antenna device according to claim 9,
wherein the second antenna is a slot antenna formed by the base plate,
the second parasitic element is a slot line formed by the base plate, and
the switch group includes a switch connected between base plates on both sides on the second parasitic element.

11. The antenna device according to claim 9,
wherein the second parasitic element includes a pair of second parasitic elements each located on either side of the second antenna.

12. The antenna device according to claim 9, further comprising:
a second feeding point provided on the second antenna; and
a second additional feeding point provided on the second parasitic element,
wherein the switch group includes a switch connected in parallel to the second feeding point and a switch connected in parallel to the second additional feeding point.

13. The antenna device according to claim 1,
wherein the base plate includes a plurality of divided base plates, and
the switch group includes a switch connected between the plurality of divided base plates.

14. The antenna device according to claim 1,
wherein the second antenna includes an antenna extending in a same direction as the first antenna.

15. The antenna device according to claim 1,
wherein the second antenna includes an antenna extending in a direction intersecting an extending direction of the first antenna.

16. The antenna device according to claim 1, further comprising
a switching unit configured to switch each switch of the switch group,
wherein the switching unit switches each switch of the switch group based on an index related to transmission and reception.

17. The antenna device according to claim 16,
wherein the index includes at least one of reception level information, transmission level information, reception Quality of Service (QoS) information, and transmission QoS information, information regarding the phase of the reception signal and the frequency characteristic of the amplitude, information regarding the phase of the transmission signal and the frequency characteristic of the amplitude, information regarding the time-axis waveform of the reception signal, or information regarding the time-axis waveform of the transmission signal.

18. The antenna device according to claim 1, further comprising
a ranging/positioning unit that performs either ranging or positioning using at least one of the first antenna or the second antenna.

19. The antenna device according to claim 17, further comprising
a ranging/positioning unit that performs either ranging or positioning by using the index for the first antenna and the index for the second antenna, and using a ranging/positioning result obtained by the first antenna and a ranging/positioning result obtained by the second antenna.

20. The antenna device according to claim 1,
wherein the first antenna, the second antenna, the parasitic element, and the base plate are provided on a substrate.
